(19) United States
(12) Patent Application Publication
(10) Pub. No.: US 2025/0234250 A1
(43) Pub. Date: Jul. 17, 2025

(54) MANAGING MULTICAST SERVICES IN HANDOVER

(71) Applicant: GOOGLE LLC, Mountain View, CA (US)

(72) Inventor: Chih-Hsiang Wu, Taoyuan City (TW)

(21) Appl. No.: 18/703,049

(22) PCT Filed: Oct. 21, 2022
(86) PCT No.: PCT/US2022/047481

§ 371 Date: Apr. 19, 2024

Related U.S. Application Data
(60) Provisional application No. 63/262,882, filed on Oct. 21, 2021.

(51) Int. Cl. H04W 36/00

(52) U.S. Cl. CPC H04W 36/0007; H04W 36/0077

(57) ABSTRACT

A method, performed by a RAN node, of managing MBS communications includes receiving, from a network node, a handover request message including a first MRB identifier associated with a first MRB for an MBS session, and transmitting, to the network node, a handover request acknowledge message including an RRC reconfiguration message. The RRC reconfiguration message indicates that a UE is to release the first MRB and add a second MRB associated with a second MRB identifier. The method also includes transmitting MBS data of the MBS session to the UE.

### FIELD OF THE DISCLOSURE

This disclosure relates to wireless communications and, more particularly, to enabling setup or modification of radio resources for multicast and/or broadcast services (MBS) for handover.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP sublayer defined for the Evolved Universal Terrestrial Radio Access (EUTRA) radio interface (see Third Generation Partnership Project (3GPP) specification TS 36.323) and New Radio (NR) (see 3GPP specification TS 38.323) provides sequencing of protocol data units (PDUs) in the uplink direction from a user device (also known as a user equipment or “UE”) to a base station, as well as in the downlink direction from the base station to the UE. The PDCP sublayer also provides services for signaling radio bearers (SRBs) to the Radio Resource Control (RRC) sublayer. The PDCP sublayer further provides services for data radio bearers (DRBs) to a Service Data Adaptation Protocol (SDAP) sublayer or a protocol layer such as an Internet Protocol (IP) layer, an Ethernet protocol layer, or an Internet Control Message Protocol (ICMP) layer. Generally, the UE and a base station can use SRBs to exchange RRC messages as well as non-access stratum (NAS) messages, and can use DRBs to transport data on a user plane.

The UE in some scenarios can concurrently utilize resources of multiple nodes (e.g., base stations or components of a distributed base station or disaggregated base station) of a radio access network (RAN), interconnected by a backhaul. When these network nodes support different radio access technologies (RATs), this type of connectivity is referred to as multi-radio dual connectivity (MR-DC). When operating in MR-DC, the cell(s) associated with the base station operating as a master node (MN) define a master cell group (MCG), and the cells associated with the base station operating as a secondary node (SN) define the secondary cell group (SCG). The MCG covers a primary cell (PCell) and zero, one, or more secondary cells (SCells), and the SCG covers a primary secondary cell (PSCell) and zero, one, or more SCells. The UE communicates with the MN (via the MCG) and the SN (via the SCG). In other scenarios, the UE utilizes resources of one base station at a time, in single connectivity (SC). The UE in SC only communicates with the MN, via the MCG. A base station and/or the UE determines when the UE should establish a radio connection with another base station. For example, a base station can determine to hand the UE over to another base station, and initiate a handover procedure. The UE in other scenarios can concurrently utilize resources of another RAN node (e.g., a base station or a component of a distributed or disaggregated base station), interconnected by a backhaul.

UEs can use several types of SRBs and DRBs. So-called “SRB1” resources carry RRC messages, which in some cases include NAS messages over the dedicated control channel (DCCH), and “SRB2” resources support RRC messages that include logged measurement information or NAS messages, also over the DCCH but with lower priority than SRB1 resources. More generally, SRB1 and SRB2 resources allow the UE and the MN to exchange RRC messages related to the MN and embed RRC messages related to the SN, and can also be referred to as MCG SRBs. “SRB3” resources allow the UE and the SN to exchange RRC messages related to the SN, and can also be referred to as SCG SRBs. Split SRBs allow the UE to exchange RRC messages directly with the MN via lower-layer resources of the MN and the SN. Further, DRBs terminated at the MN and using the lower-layer resources of only the MN can be referred as MCG DRBs, DRBs terminated at the SN and using the lower-layer resources of only the SN can be referred as SCG DRBs, and DRBs terminated at the MN or SN but using the lower-layer resources of both the MN and the SN can be referred to as split DRBs. DRBs terminated at the MN but using the lower-layer resources of only the SN can be referred to as MN-terminated SCG DRBs. DRBs terminated at the SN but using the lower-layer resources of only the MN can be referred to as SN-terminated MCG DRBs.

UEs can perform handover procedures to switch from one cell to another, whether in SC or DC operation. These procedures involve messaging (e.g., RRC signaling and preparation) among RAN nodes and the UE. The UE may handover from a cell of a serving base station to a target cell of a target base station, or from a cell of a first distributed unit (DU) of a serving base station to a target cell of a second DU of the same base station, depending on the scenario. In DC scenarios, UEs can perform PSCell change procedures to change PSCells. These procedures involve messaging (e.g., RRC signaling and preparation) among RAN nodes and the UE. The UE may perform a PSCell change from a PSCell of a serving SN to a target PSCell of a target SN, or from a PSCell of a source DU of a base station to a PSCell of a target DU of the same base station, depending on the scenario. Further, the UE may perform handover or PSCell change within a cell for synchronous reconfiguration.

Base stations that operate according to fifth-generation (5G) New Radio (NR) requirements support significantly larger bandwidth than fourth-generation (4G) base stations. Accordingly, the Third Generation Partnership Project (3GPP) has proposed that for Release 15, UEs support a 100 MHz bandwidth in frequency range 1 (FR1) and a 400 MHZ bandwidth in frequency range (FR2). Due to the relatively wide bandwidth of a typical carrier in 5G NR, 3GPP has proposed for Release 17 that a 5G NR base station be able to provide multicast and/or broadcast service(s) (MBS) to UEs. MBS can be useful in many content delivery applications, such as transparent IPv4/IPv6 multicast delivery, IPTV, software delivery over wireless, group communications, Internet of Things (IoT) applications, V2X applications, and emergency messages related to public safety, for example.

5G NR provides both point-to-point (PTP) and point-to-multipoint (PTM) delivery methods for the transmission of MBS packet flows over the radio interface. In PTP communications, a RAN node transmits different copies of each MBS data packet to different UEs over the radio interface, while in PTM communications a RAN node transmits a single copy of each MBS data packet to multiple UEs over the radio interface. In some scenarios, however, such as mobility scenarios, it is unclear how a base station and/or core network (CN) handle MBS communications.

### SUMMARY

In one aspect of this disclosure, a method, performed by a RAN node, of managing MBS communications includes receiving, from a network node, a handover request message including a first MRB identifier associated with a first MRB for an MBS session, and transmitting, to the network node, a handover request acknowledge message including an RRC reconfiguration message. The RRC reconfiguration message indicates that a UE is to release the first MRB and add a second MRB associated with a second MRB identifier. The method also includes transmitting MBS data of the MBS session to the UE.

In another aspect, a method, performed by a network node, of managing MBS communications includes transmitting, to a RAN node, a handover request message including a first MRB identifier associated with a first MRB for an MBS session, and receiving, from the RAN node, a handover request acknowledge message including an RRC reconfiguration message. The RRC reconfiguration message indicates that a UE is to release the first MRB and add a second MRB associated with a second MRB identifier. The method also includes transmitting the RRC reconfiguration message to the UE.

In another aspect, a method, performed by a UE, of managing MBS communications includes receiving MBS data of an MBS session from a first RAN node via a first MRB, receiving, from the first RAN node, an RRC message, and, based on the RRC message, releasing the first MRB and adding a second MRB. The method also includes receiving other MBS data of the MBS session from a second RAN node via the second MRB.

In another aspect, a method, performed by a RAN node, of managing MBS communications includes configuring, for a UE, a DRB associated with a PDU session, configuring, for the UE, an MRB associated with an MBS session, transmitting MBS data to the UE via the MRB, releasing the MRB, and, after the releasing, transmitting other MBS data to the UE via the DRB.

### BRIEF DESCRIPTION OF THE DRAWINGS

FIG. 1A is a block diagram of an example system in which the techniques of this disclosure for managing transmission and reception of MBS information can be implemented;

FIG. 1B is a block diagram of an example base station in which a centralized unit (CU) and a distributed unit (DU) can operate in the system of FIG. 1A;

FIG. 2A is a block diagram of an example protocol stack according to which the UE of FIG. 1A can communicate with base stations of FIG. 1A;

FIG. 2B is a block diagram of an example protocol stack according to which the UE of FIG. 1A can communicate with a DU and a CU of a base station;

FIG. 3 is a block diagram illustrating example tunnel architectures for MBS sessions and PDU sessions;

FIGS. 4A-4B are messaging diagrams of example scenarios in which a CN and a base station establish a common downlink (DL) tunnel or a UE-specific DL tunnel via which the CN can transmit MBS data of an MBS session, for one or multiple UEs, to the base station, and the base station transmits the MBS data to the one or multiple UEs via a MRB or a DRB;

FIGS. 5A-5C are messaging diagrams of example scenarios in which a RAN configures or reconfigures radio resources for an MBS session during handover preparation;

FIG. 6 is a flow diagram of an example method for configuring multiple RAN nodes to assign the same MRB ID for a particular MBS session ID, which can be implemented in a core network (CN) of FIG. 1A or in a network node (e.g., Operations, Administration and Maintenance (OAM), not shown in FIG. 1A);

FIG. 7 is a flow diagram of an example method for configuring a MRB ID for a particular MBS session ID, which can be implemented in a base station of FIG. 1A or a CU of FIG. 1B;

FIGS. 8-11 are flow diagrams of example methods for managing configurations for MBS reception in handover preparation, which can be implemented in a base station of FIG. 1A or a CU of FIG. 1B; and

FIG. 12 is a flow diagram of an example method for receiving MBS data, which can be implemented in a UE of FIG. 1A.

### DETAILED DESCRIPTION OF THE DRAWINGS

Generally, a radio access network (RAN) and/or a core network (CN) can implement the techniques of this disclosure to manage transmission of multicast and/or broadcast services (MBS). A CN can request that a base station configure a common downlink (DL) tunnel via which the CN can transmit MBS data for an MBS session to the base station, for multiple user equipment (UEs). In response to the request, the base station transmits a configuration of the common DL tunnel to the CN. The configuration can include transport-layer information such as an Internet Protocol (IP) address and a tunnel identifier (e.g., a Tunnel Endpoint Identifier (TEID)).

The base station can also configure one or more logical channels toward the UEs, and/or one or more MBS radio bearers (MRBs) associated with the MBS session, where there may be a one-to-one mapping between each logical channel and each MRB. After receiving MBS data for the MBS session via the common DL tunnel, the base station can transmit the MBS data via the one or more logical channels to one or more UEs that have joined the MBS session. In some implementations, the base station transmits MBS data to multiple UEs via a single logical channel. Further, if there are multiple quality-of-service (QOS) flows for the MBS session, a single logical channel may be associated with the multiple QoS flows, or there may be a one-to-one mapping between each QoS flow and each logical channel.

The CN can cause the base station to configure the common DL tunnel before or after a UE joins the MBS session. If additional UEs join the MBS session after the tunnel is configured, the CN can utilize the same common DL tunnel to transmit MBS data, for the multiple UEs, to the base station.

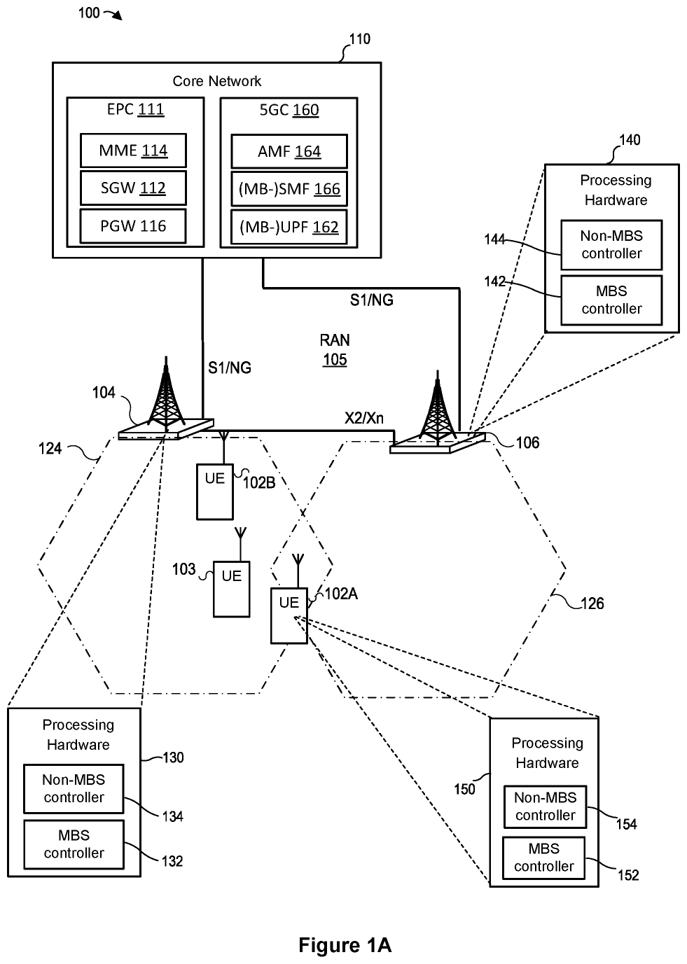

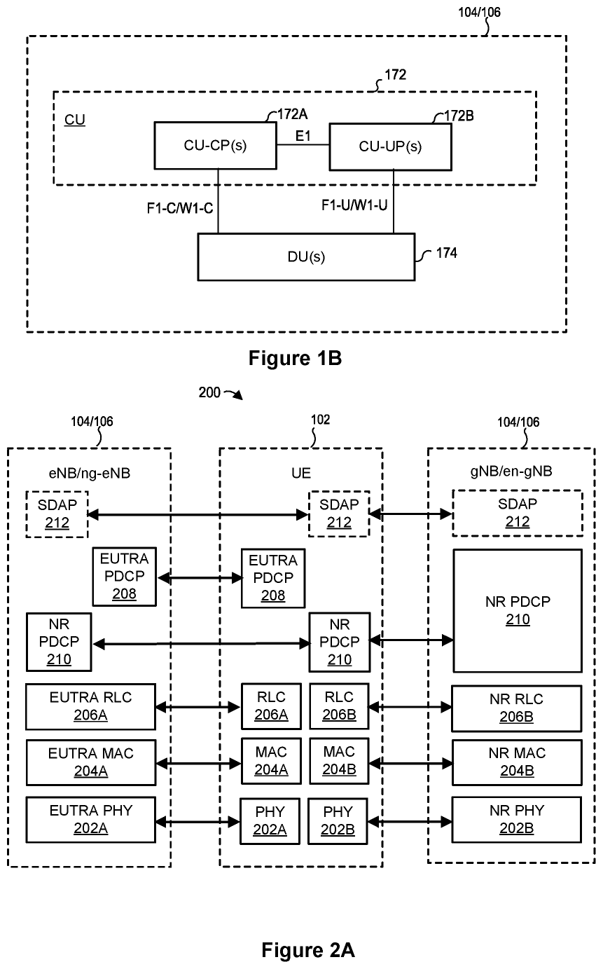

FIG. 1A depicts an example wireless communication system 100 in which techniques of this disclosure for managing transmission and reception of MBS information can be implemented. The wireless communication system 100 includes UEs 102A, 102B, 103 as well as base stations 104, 106 of a RAN 105 connected to a CN 110. In other implementations or scenarios, the wireless communication system 100 may instead include more or fewer UEs, and/or more or fewer base stations, than are shown in FIG. 1A. The base stations 104, 106 can be of any suitable type, or types, of base stations, such as an evolved node B (eNB), a next-generation eNB (ng-eNB), or a 5G Node B (gNB), for example. As a more specific example, the base station 104 may be an eNB or a gNB, and the base stations 106 may be a gNB.

The base station 104 supports a cell 124, and the base station 106 supports a cell 126. The cell 124 partially overlaps with the cell 126, so that the UE 102A can be in range to communicate with base station 104 while simultaneously being in range to communicate with the base station 106 (or in range to detect or measure signals from the base station 106). The overlap can make it possible for the UE 102A to hand over between the cells (e.g., from the cell 124 to the cell 126) or base stations (e.g., from the base station 104 to the base station 106) before the UE 102A experiences radio link failure, for example. Moreover, the overlap allows for various dual connectivity (DC) scenarios. For example, the UE 102A can communicate in DC with the base station 104 (operating as a master node (MN)) and the base station 106 (operating as a secondary node (SN)). When the UE 102A is in DC with the base station 104 and the base station 106, the base station 104 operates as a master eNB (MeNB), a master ng-eNB (Mng-eNB), or a master gNB (MgNB), and the base station 106 operates as a secondary gNB (SgNB) or a secondary ng-eNB (Sng-eNB).

In non-MBS (unicast) operation, the UE 102A can use a radio bearer (e.g., a DRB or an SRB) that at different times terminates at an MN (e.g., the base station 104) or an SN (e.g., the base station 106). For example, after handover or SN change to the base station 106, the UE 102A can use a radio bearer (e.g., a DRB or an SRB) that terminates at the base station 106. The UE 102A can apply one or more security keys when communicating on the radio bearer, in the uplink (from the UE 102A to a base station) and/or downlink (from a base station to the UE 102A) direction. In non-MBS operation, the UE 102A transmits data via the radio bearer on (i.e., within) an uplink (UL) bandwidth part (BWP) of a cell to the base station, and/or receives data via the radio bearer on a downlink (DL) BWP of the cell from the base station. The UL BWP can be an initial UL BWP or a dedicated UL BWP, and the DL BWP can be an initial DL BWP or a dedicated DL BWP. The UE 102A can receive paging, system information, public warning message(s), or a random access response on the DL BWP. In this non-MBS operation, the UE 102A can be in a connected state. Alternatively, the UE 102A can be in an idle or inactive state if the UE 102A supports small data transmission (which can also be referred to as “early data transmission”) in the idle or inactive state.

In MBS operation, the UE 102A can use an MBS radio bearer (MRB) that at different times terminates at an MN (e.g., the base station 104) or an SN (e.g., the base station 106). For example, after handover or SN change, the UE 102A can use an MRB that terminates at the base station 106, which can be operating as an MN or SN. In some scenarios, a base station (e.g., the MN or SN) can transmit MBS data over unicast radio resources (i.e., the radio resources dedicated to the UE 102A) to the UE 102A via the MRB. In other scenarios, the base station (e.g., the MN or SN) can transmit MBS data over multicast radio resources (i.e., the radio resources common to the UE 102A and one or more other UEs), or a DL BWP of a cell from the base station to the UE 102A via the MRB. The DL BWP can be an initial DL BWP, a dedicated DL BWP, or an MBS DL BWP (i.e., a DL BWP that is specific to MBS, or not for unicast).

The base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation of FIG. 1A includes an MBS controller 132 that is configured to manage or control transmission of MBS information received from the CN 110 or an edge server. For example, the MBS controller 132 can be configured to support radio resource control (RRC) configurations, procedures and messaging associated with MBS procedures, and/or other operations associated with those configurations and/or procedures, as discussed below. The processing hardware 130 can also include a non-MBS controller 134 that is configured to manage or control one or more RRC configurations and/or RRC procedures when the base station 104 operates as an MN or SN during a non-MBS operation.

The base station 106 includes processing hardware 140, which can include one or more general-purpose processors (e.g., CPUs) and a computer-readable memory storing machine-readable instructions executable on the general-purpose processor(s), and/or special-purpose processing units. The processing hardware 140 in the example implementation of FIG. 1A includes an MBS controller 142 and a non-MBS controller 144, which may be similar to the controllers 132 and 134, respectively, of base station 130. Although not shown in FIG. 1A, the RAN 105 can include additional base stations with processing hardware similar to the processing hardware 130 of the base station 104 and/or the processing hardware 140 of the base station 106.

The UE 102A includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes an MBS controller 152 that is configured to manage or control reception of MBS information. For example, the MBS controller 152 can be configured to support RRC configurations, procedures and messaging associated with MBS procedures, and/or other operations associated with those configurations and/or procedures, as discussed below. The processing hardware 150 can also include a non-MBS controller 154 configured to manage or control one or more RRC configurations and/or RRC procedures in accordance with any of the implementations discussed below, when the UE 102A communicates with an MN and/or an SN during a non-MBS operation. Although not shown in FIG. 1A, the UEs 102B, 103 may each include processing hardware similar to the processing hardware 150 of the UE 102A.

The CN 110 may be an evolved packet core (EPC) 111 or a fifth-generation core (5GC) 160, both of which are depicted in FIG. 1A. The base station 104 may be an eNB supporting an S1 interface for communicating with the EPC 111, an ng-eNB supporting an NG interface for communicating with the 5GC 160, or a gNB that supports an NR radio interface as well as an NG interface for communicating with the 5GC 160. The base station 106 may be an EUTRA-NR DC (EN-DC) gNB (en-gNB) with an S1 interface to the EPC 111, an en-gNB that does not connect to the EPC 111, a gNB that supports the NR radio interface and an NG interface to the 5GC 160, or a ng-eNB that supports an EUTRA radio interface and an NG interface to the 5GC 160. To directly exchange messages with each other during the scenarios discussed below, the base stations 104 and 106 may support an X2 or Xn interface.

Among other components, the EPC 111 can include a serving gateway (SGW) 112, a mobility management entity (MME) 114, and a packet data network gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from a UE (e.g., UE 102A or 102B) to one or more external packet data networks, e.g., an Internet network and/or an Internet Protocol (IP) Multimedia Subsystem (IMS) network. The 5GC 160 includes a user plane function (UPF) 162 and an access and mobility management (AMF) 164, and/or a session management function (SMF) 166. The UPF 162 is generally configured to transfer user-plane packets related to audio calls, video calls, Internet traffic, etc., the AMF 164 is generally configured to manage authentication, registration, paging, and other related functions, and the SMF 166 is generally configured to manage PDU sessions.

The UPF 162, AMF 164, and/or SMF 166 can be configured to support MBS. For example, the SMF 166 can be configured to manage or control MBS transport, configure the UPF 162 and/or RAN 105 for MBS flows, and/or manage or configure one or more MBS sessions or PDU sessions for MBS for a UE (e.g., UE 102A or 102B). The UPF 162 is configured to transfer MBS data packets to audio, video, Internet traffic, etc. to the RAN 105. The UPF 162 and/or SMF 166 can be configured for both non-MBS unicast service and MBS, or for MBS only.

Generally, the wireless communication system 100 may include any suitable number of base stations supporting NR cells and/or EUTRA cells. More particularly, the EPC 111 or the 5GC 160 may be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies, such as sixth generation (6G) radio access and/or 6G core network or 5G NR-6G DC, for example.

In different configurations or scenarios of the wireless communication system 100, the base station 104 can operate as an MeNB, an Mng-eNB, or an MgNB, and the base station 106 can operate as an SgNB or an Sng-eNB. The UE 102A can communicate with the base station 104 and the base station 106 via the same radio access technology (RAT), such as EUTRA or NR, or via different RATs.

When the base station 104 is an MeNB and the base station 106 is an SgNB, the UE 102A can be in EN-DC with the MeNB 104 and the SgNB 106. When the base station 104 is an Mng-eNB and the base station 106 is an SgNB, the UE 102A can be in next generation (NG) EUTRA-NR DC (NGEN-DC) with the Mng-eNB 104 and the SgNB 106. When the base station 104 is an MgNB and the base station 106 is an SgNB, the UE 102A can be in NR-NR DC (NR-DC) with the MgNB 104 and the SgNB 106. When the base station 104 is an MgNB and the base station 106 is an Sng-eNB, the UE 102A can be in NR-EUTRA DC (NE-DC) with the MgNB 104 and the Sng-eNB 106.

FIG. 1B depicts an example distributed implementation of each of one or both of the base stations 104 and 106. In this implementation, the base station 104, 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include some or all of the processing hardware 130 or 140 of FIG. 1A.

Each of the DU(s) 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 104) operates as an MN or an SN. The processing hardware can also include a physical (PHY) layer controller configured to manage or control one or more PHY layer operations or procedures.

In some implementations, the CU 172 can include one or more logical nodes (CU-CP(s) 172A) that host the control plane part of the Packet Data Convergence Protocol (PDCP) protocol of the CU 172 and/or the radio resource control (RRC) protocol of the CU 172. The CU 172 can also include one or more logical nodes (CU-UP(s) 172B) that host the user plane part of the PDCP protocol and/or service data adaptation protocol (SDAP) protocol of the CU 172. The CU-CP(s) 172A can transmit non-MBS control information and MBS control information, and the CU-UP(s) 172B can transmit non-MBS data packets and MBS data packets, as described herein.

The CU-CP(s) 172A can be connected to multiple CU-UPs 172B through the E1 interface. The CU-CP(s) 172A select the appropriate CU-UP(s) 172B for the requested services for the UE 102A. In some implementations, a single CU-UP 172B can be connected to multiple CU-CPs 172A through the E1 interface. A CU-CP 172A can be connected to one or more DUs 174s through an F1-C interface. A CU-UP 172B can be connected to one or more DUs 174 through an F1-U interface under the control of the same CU-CP 172A. In some implementations, one DU 174 can be connected to multiple CU-UPs 172B under the control of the same CU-CP 172A. In such implementations, the connectivity between a CU-UP 172B and a DU 174 is established by the CU-CP 172A using bearer context management functions.

The description above can apply to the UEs 102B and 103.

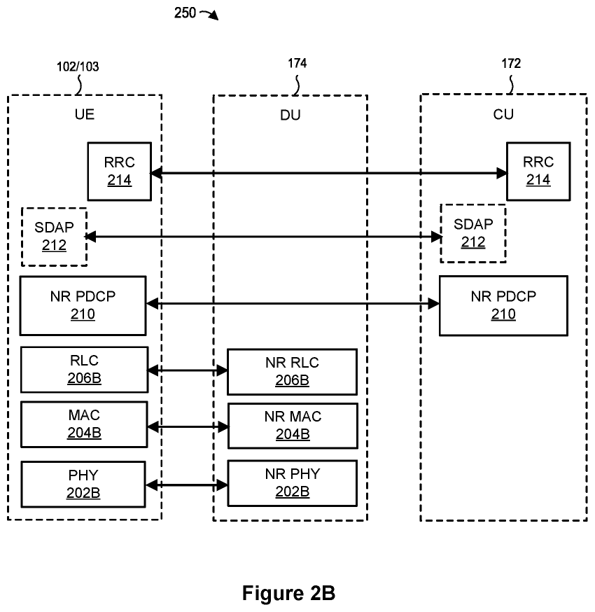

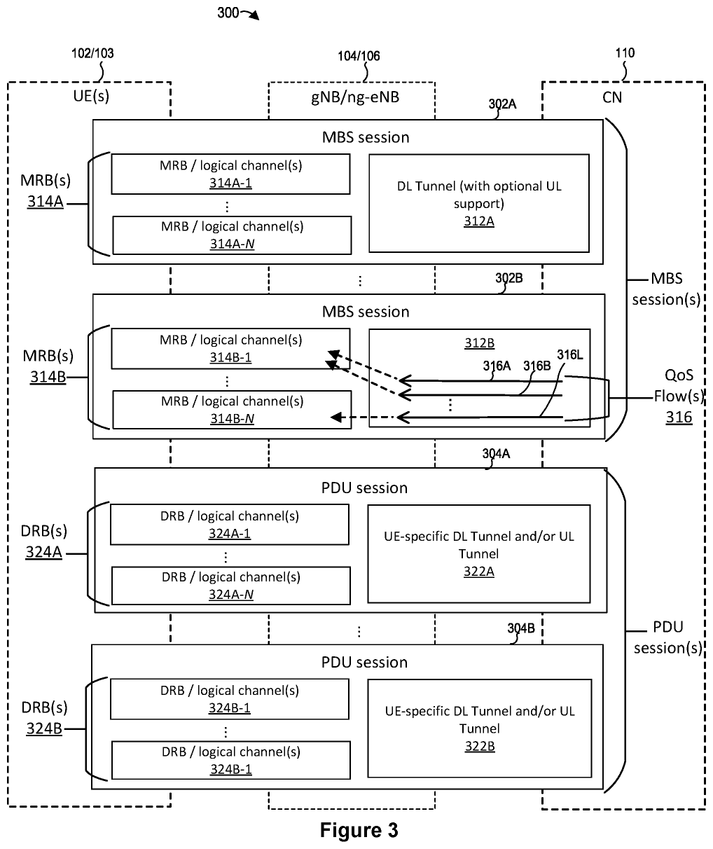

FIG. 2A illustrates, in a simplified manner, an example protocol stack 200 according to which a UE (e.g., UE 102A, 102B, or 103) can communicate with an eNB/ng-eNB or a gNB/en-gNB (e.g., one or both of the base stations 104, 106). In the example protocol stack 200, a PHY sublayer 202A of EUTRA provides transport channels to an EUTRA MAC sublayer 204A, which in turn provides logical channels to an EUTRA RLC sublayer 206A. The EUTRA RLC sublayer 206A in turn provides RLC channels to an EUTRA PDCP sublayer 208 and, in some cases, to an NR PDCP sublayer 210. Similarly, an NR PHY 202B provides transport channels to an NR MAC sublayer 204B, which in turn provides logical channels to an NR RLC sublayer 206B. The NR RLC sublayer 206B in turn provides RLC channels to an NR PDCP sublayer 210. The UE, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE can support layering of NR PDCP 210 over EUTRA RLC 206A, and an SDAP sublayer 212 over the NR PDCP sublayer 210. Sublayers are also referred to herein as simply “layers.”

The EUTRA PDCP sublayer 208 and the NR PDCP sublayer 210 receive packets (e.g., from an IP layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.” The packets can be MBS packets or non-MBS packets. MBS packets may include application content for an MBS service (e.g., IPv4/IPv6 multicast delivery, IPTV, software delivery over wireless, group communications, IoT applications, V2X applications, and/or emergency messages related to public safety), for example. As another example, MBS packets may include application control information for the MBS service.

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 may be SDAP PDUs, IP packets, or Ethernet packets, for example.

In scenarios where the UE 102A or 102B operates in EN-DC with the base station 104 operating as an MeNB and the base station 106 operating as an SgNB, the wireless communication system 100 can provide the UE 102A or 102B with an MN-terminated bearer that uses EUTRA PDCP sublayer 208, or an MN-terminated bearer that uses NR PDCP sublayer 210. The wireless communication system 100 in various scenarios can also provide the UE with an SN-terminated bearer, which uses only the NR PDCP sublayer 210. The MN-terminated bearer may be an MCG bearer, a split bearer, or an MN-terminated SCG bearer. The SN-terminated bearer may be an SCG bearer, a split bearer, or an SN-terminated MCG bearer. The MN-terminated bearer may be an SRB (e.g., SRB1 or SRB2) or a DRB. The SN-terminated bearer may be an SRB or a DRB.

In some implementations, a base station (e.g., base station 104 or 106) broadcasts or multicasts MBS data packets via one or more MRB(s), and in turn the receives the MBS data packets via the MRB(s). The base station can include configuration(s) of the MRB(s) in multicast configuration parameters (which can also be referred to as MBS configuration parameters) described below. In some implementations, the base station broadcasts the MBS data packets via RLC sublayer 206, MAC sublayer 204, and PHY sublayer 202, and correspondingly, the UE uses PHY sublayer 202, MAC sublayer 204, and RLC sublayer 206 to receive the MBS data packets. In such implementations, the base station and the UE may not use PDCP sublayer 208 and a SDAP sublayer 212 to communicate the MBS data packets. In other implementations, the base station transmits the MBS data packets via PDCP sublayer 208, RLC sublayer 206, MAC sublayer 204, and PHY sublayer 202, and correspondingly, the UE uses PHY sublayer 202, MAC sublayer 204, RLC sublayer 206 and PDCP sublayer 208 to receive the MBS data packets. In such implementations, the base station and the UE may not use a SDAP sublayer 212 to communicate the MBS data packets. In yet other implementations, the base station transmits the MBS data packets via the SDAP sublayer 212, PDCP sublayer 208, RLC sublayer 206, MAC sublayer 204, and PHY sublayer 202 and, correspondingly, the UE uses the PHY sublayer 202, MAC sublayer 204, RLC sublayer 206, PDCP sublayer 208, and SDAP sublayer 212 to receive the MBS data packets.

FIG. 2B illustrates, in a simplified manner, an example protocol stack 250 which the UE 102A, 102B, or 103 can use to communicate with a DU (e.g., DU 174) and a CU (e.g., CU 172). The radio protocol stack 200 is functionally split as shown by the radio protocol stack 250 in FIG. 2B. The CU at either of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

Referring next to FIG. 3, which depicts example architectures 300 for MBS sessions and PDU sessions, an MBS session 302A can include a tunnel 312A with endpoints at the CN 110 and the base station 104/106 (i.e., the base station 104 or the base station 106). The MBS session 302A can correspond to a certain session ID such as a Temporary Mobile Group Identity (TMGI), for example. The MBS data can include IP packets, TCP/IP packets, UDP/IP packets, Real-Time Transport Protocol (RTP)/UDP/IP packets, or RTP/TCP/IP packets, for example.

In some cases, the CN 110 and/or the base station 104/106 configure the tunnel 312A only for MBS traffic directed from the CN 110 to the base station 104/106, and the tunnel 312A can be referred to as a downlink (DL) tunnel. In other cases, however, the CN 110 and the base station 104/106 use the tunnel 312A for downlink as well as for uplink (UL) MBS traffic to support, for example, commands or service requests from UEs. Further, because the base station 104/106 can direct MBS traffic arriving via the tunnel 312A to multiple UEs, the tunnel 312A can be referred to as a common tunnel or a common DL tunnel.

The tunnel 312A can operate at the transport layer or sublayer, e.g., on the User Datagram Protocol (UDP) protocol layered over Internet Protocol (IP). As a more specific example, the tunnel 312A can be associated with the General Packet Radio System (GPRS) Tunneling Protocol (GTP). The tunnel 312A can correspond to a certain IP address (e.g., an IP address of the base station 104/106) and a certain Tunnel Endpoint Identifier (TEID) (e.g., assigned by the base station 104/106), for example. More generally, the tunnel 312A can have any suitable transport-layer configuration. The CN 110 can specify the IP address and the TEID address in header(s) of a tunnel packet including an MBS data packet and transmit the tunnel packet downstream to the base station 104/106 via the tunnel 312A. The header(s) can include the IP address and/or the TEID. For example, the header(s) includes an IP header and an GTP header including the IP address and the TEID, respectively. The base station 104/106 accordingly can identify data packets traveling via the tunnel 312A using the IP address and/or the TEID.

As illustrated in FIG. 3, the base station 104/106 maps traffic in the tunnel 312A to N radio bearers 314A-1, 314A-2, . . . 314A-N, which may be configured as MBS radio bearers or MRBs, where N≥1. Each MRB can correspond to a respective logical channel. As discussed above, the PDCP sublayer provides support for radio bearers such as SRBs, DRBs, and MRBs, and a EUTRA or NR MAC sublayer provides logical channels to a EUTRA or NR RLC sublayer. Each of the MRBs 314A for example can correspond to a respective MBS Traffic Channel (MTCH). The base station 104/106 and the CN 110 can also maintain another MBS session 302B, which similarly can include a tunnel 312B corresponding to MRBs 314B-1, 314B-2 . . . 314B-N, where N≥1. Each of the MRBs 314B can correspond to a respective logical channel.

The MBS traffic can include one or multiple quality-of-service (QOS) flows, for each of the tunnels 312A, 312B, etc. For example, the MBS traffic on the tunnel 312B can include a set of flows 316 including QoS flows 316A, 316B . . . 316L, where L>1. Further, a logical channel of an MRB can support a single QoS flow or multiple QoS flows. In the example configuration of FIG. 3, the base station 104/106 maps the QoS flows 316A and 316B to the MTCH of the MRB 314B-1, and the QoS flow 316L to the MTCH of the MRB 314B-N.

In various scenarios, the CN 110 can assign different types of MBS traffic to different QoS flows. A flow with a relatively high QoS value can correspond to audio packets, and a flow with a relatively low QoS value can correspond to video packets, for example. As another example, a flow with a relatively high QoS value can correspond to I-frames or complete images used in video compression, and a flow with a relatively low QoS value can correspond to P-frames or predicted pictures that include only changes to I-frames.

With continued reference to FIG. 3, the base station 104/106 and the CN 110 can maintain one or more PDU sessions to support unicast traffic between the CN 110 and particular UEs. A PDU session 304A can include a UE-specific DL tunnel and/or UE-specific DL tunnel 322A corresponding to one or more DRBs 324A, such as a DRB 324A-1, 324A-2 . . . 324-N. Each of the DRBs 324A can correspond to a respective logical channel, such as a Dedicated Traffic Channel (DTCH).

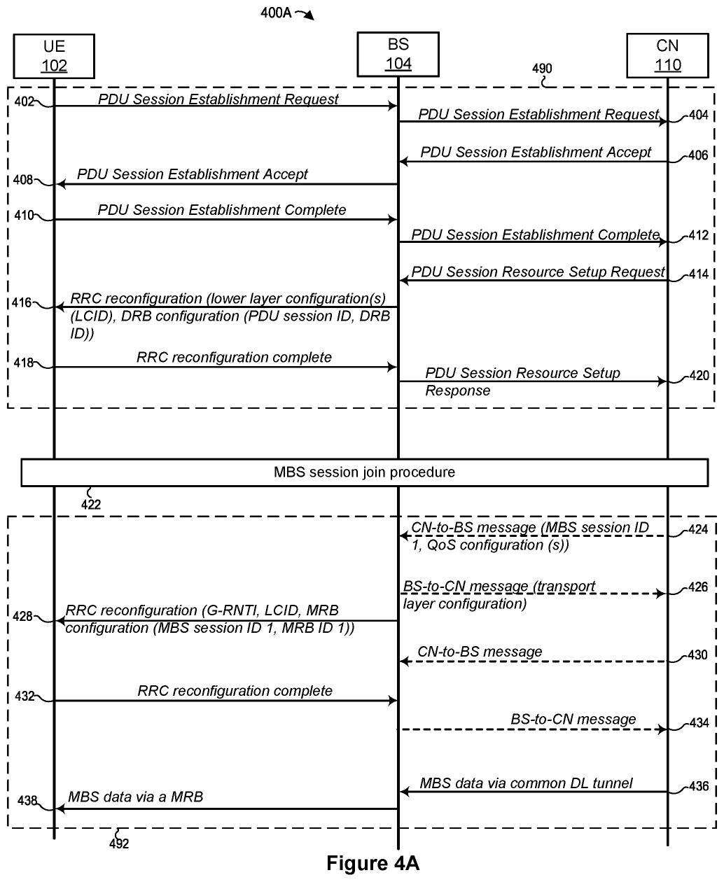

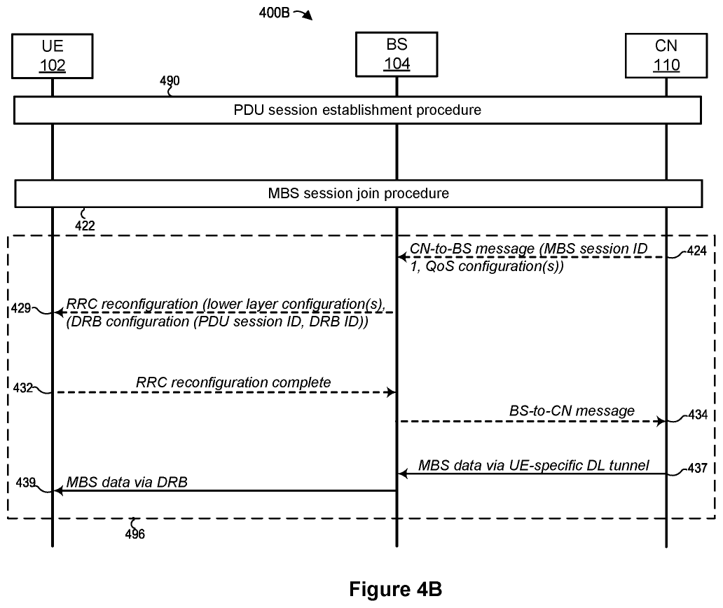

Now referring to FIG. 4A, in an example scenario 400A, the base station (BS) 104 configures a common tunnel for MBS data in response to the CN requesting resources for an MBS session. In the following description, the UE 102 can represent the UE 102A and/or the UE 102B.

The UE 102 initially performs a PDU session establishment procedure 490 with the CN 110 via the base station 104 to establish a PDU session to receive MBS. More specifically, the UE 102 transmits 402 a PDU Session Establishment Request message to the bacs station 104, which in turn transmits 404 (a BS-to-CN message including) the PDU Session Establishment Request message to the CN 110. In response, the CN 110 can send 406 (a CN-to-BS message including) a PDU Session Establishment Accept message to the base station 104, which in turn transmits 408 the PDU Session Establishment Accept message to the UE 102. In response to the PDU Session Establishment Accept message, the UE 102 transmits 410 a PDU Session Establishment Complete message to the base station 104, which in turn transmits 412 (a BS-to-CN message including) the PDU Session Establishment Complete message to the CN 110.

In some implementations, the UE 102 can generate a container message including the PDU Session Establishment Request message and transmit 402, 404 the container message to the CN 110 via the base station 104. Similarly, the CN 110 can generate a container message including the PDU Session Establishment Accept message and transmit 406, 408 the container message to the UE 102 via the base station 104. Likewise, the UE 102 can generate a container message including the PDU Session Establishment Complete message and transmit 410, 412 the container message to the CN 110 via the base station 104.

To simplify the following description, the PDU Session Establishment Request message, the PDU Session Establishment Accept message, and the PDU Session Establishment Complete message can represent the respective container messages.

In some implementations, the UE 102 can include, in the PDU Session Establishment Request message, a PDU session ID identifying the PDU session, slice information associated with an MBS session of event 422, and/or a particular data network name (DNN) (e.g., “MBS” or “mbs”). In some implementations, the CN 110 may include the PDU session ID in the PDU Session Establishment Accept message.

In response to or after receiving 406 the message, the CN 110 can send 414 to the base station 104 a CN-to-BS message (e.g., a PDU Session Resource Setup Request message) to request the base station 104 to configure resources for the PDU session. In some implementations, the CN 110 can include the PDU session ID in the CN-to-BS message. In response to the CN-to-BS message, the base station 104 can send 416 to the UE 102 an RRC reconfiguration message including unicast configuration parameters. In response, the UE 102 transmits 418 an RRC reconfiguration complete message to the base station 104. The base station 104 can transmit 420 a BS-to-CN message (e.g., a PDU Session Resource Setup Response message) to the CN 110 after or before receiving 420 the RRC reconfiguration complete message. In some implementations, the CN 110 can include, in the CN-to-BS message of event 406 or event 414, a UL transport layer configuration configuring a UE-specific UL tunnel for the PDU session with the UE 102. Alternatively, the CN 110 refrains from configuring a UE-specific UL tunnel for the PDU session with the UE 102. The UL transport layer configuration includes a transport layer address (e.g., an IP address) and/or a TEID to identify the UE-specific UL tunnel. In some implementations, the base station 104 can include, in the BS-to-CN message of event 412 or event 420 a DL transport layer configuration configuring a UE-specific DL tunnel for the PDU session with the UE 102. The DL transport layer configuration includes a transport layer address (e.g., an IP address) and/or a TEID to identify the UE-specific DL tunnel.

In some implementations, the CN-to-BS message of the event 406 and the CN-to-BS message of the event 414 can be combined as a single CN-to-BS message. For example, the CN 110 can include the PDU Session Establishment Accept message in the CN-to-BS message of the event 414 and the event 406 can be omitted. In some implementations, the base station 104 can include the PDU Session Establishment Accept message in the RRC reconfiguration message of event 416 or transmit the PDU Session Establishment Accept message after transmitting 416 the RRC reconfiguration message. In such cases, the UE 102 can include the PDU Session Establishment Complete message in the RRC reconfiguration complete message of event 418 or transmit the PDU Session Establishment Complete message before or after transmitting 418 the RRC reconfiguration complete message. In some implementations, the base station 104 can include the PDU Session Establishment Complete message in the BS-to-CN message of the event 420.

In some implementations, the unicast configuration parameters can include a (first) DRB configuration (e.g., a DRB-ToAddMod IE) and first lower layer configuration(s). The DRB configuration configures a (first) DRB. The DRB configuration includes a DRB ID (e.g., drb-Identity or DRB-Identity) identifying the DRB, and includes the PDU session ID to indicate that the DRB (ID) associated with the PDU session (ID). The DRB configuration can also include a PDCP configuration and/or an SDAP configuration.

In some implementations, the (first) lower layer configuration(s) are associated with the DRB configuration. The lower layer configuration(s) include a (first) logical channel identity (ID) (e.g., LogicalChannelIdentity IE) identifying a logical channel (e.g., a dedicated traffic channel (DTCH)), an RLC configuration (e.g., RLC-Config IE), and/or a logical channel configuration (e.g., LogicalChannelConfig IE). In some implementations, the base station 104 can exclude the logical channel configuration from the RRC reconfiguration message 416. In some implementations, the lower layer configuration can be or include an RLC bearer configuration (e.g., RLC-BearerConfig IE), which can include the DRB ID, the logical channel ID, the RLC configuration, and/or the logical channel configuration. In some implementations, the lower configuration can be a cell group configuration (e.g., CellGroupConfig IE). In some implementations, the lower layer configuration includes a MAC configuration (e.g., MAC-CellGroupConfig IE) or a physical layer configuration (e.g., PhysicalCellGroupConfig IE).

After performing the PDU session establishment procedure 490, the UE 102 performs an MBS session join procedure 422 with the CN 110 via the base station 104 to join a certain MBS session (e.g., a first MBS session). To perform the MBS session join procedure 422, the UE 102 in some implementations sends an MBS session join request message to the base station 104, which in turn transmits the MBS session join request message to the CN 110. In response, the CN 110 can send an MBS session join response message to the UE 102 via the base station 104 to grant the UE 102 access to the MBS session. In some implementations, the UE 102 can include a (first) MBS session ID of the MBS session in the MBS session join request message. The CN 110 in some cases includes the MBS session ID in the MBS session join response message. In some implementations, the UE 102 can send an MBS session join complete message to the CN 110 via the base station 104 in response to the MBS session join response message. In some implementations, the UE 102 may include the MBS session ID in the PDU Session Establishment Request message of event 402 or the PDU Session Establishment Complete message of event 410.

In some implementations, the MBS session join request message, MBS session join response message, and MBS session join complete message can be session initiation protocol (SIP) messages. In other implementations, the MBS session join request message, MBS session join response message, and MBS session join complete message can be NAS messages such as 5G mobility management (5GMM) messages or 5G session management messages (5GSM). In the case of the 5GSM messages, the UE 102 can transmit to the CN 110 via the base station 104 a (first) UL container message including the MBS session join request message, the CN 110 can transmit to the UE 102 via the base station 104 a DL container message including the MBS session join response message, and the UE 102 can transmit to the CN 110 via the base station 104 a (second) UL container message including the MBS session join complete message. These container messages can be 5GMM messages. In some implementations, the MBS session join request message, MBS session join response message, and MBS session join complete message can be a PDU Session Modification Request message, a PDU Session Modification Command message, and a PDU Session Modification Complete message, respectively. To simplify the following description, the MBS session join request message, the MBS session join response message, and/or the MBS session join complete message can represent their respective container messages.

During the MBS session join procedure 422, the UE 102 can communicate the PDU session ID with the CN 110 via the base station 104. For example, the UE 102 can include the PDU session ID in the MBS session join request message or the MBS session join complete message, and/or the CN 110 can include the PDU session ID in the MBS session join response message. In some implementations, the PDU session IDs of the UE 102A and UE 102B can be the same (i.e., have the same value). In other implementations, the PDU session IDs of the UE 102A and UE 102B can be the different (i.e., have different values).

Before, during, or after the MBS session join procedure 422, the CN 110 can send 424 a (first) CN-to-BS message including the MBS session ID and/or the PDU session ID to the base station 104 to request the base station 104 to configure resources for the MBS session. The CN 110 can additionally include, in the CN-to-BS message, quality of service (QoS) configuration(s) for the MBS session. In response, the base station 104 can (determine to) send 426 a (first) BS-to-CN message including a DL transport layer configuration to configure a common DL tunnel for the CN 110 to send MBS data to the base station 104. The DL transport layer configuration includes a transport layer address (e.g., an IP address) and/or a TEID to identify the common DL tunnel. The base station 104 can include the MBS session ID and/or the PDU session ID in the BS-to-CN message. In cases where the base station 104 has configured a common DL tunnel for the MBS session before receiving the BS-to-CN message, the base station 104 determines not to send the BS-to-CN message. That is, the base station 104 refrains from sending the BS-to-CN message in such cases.

In some implementations, the CN-to-BS message of event 424 can be a generic NGAP message or a dedicated NGAP message defined specifically for requesting resources for an MBS session (e.g., MBS Session Resource Setup Request message). In some implementations, the BS-to-CN message of event 426 is a generic NGAP message or a dedicated NGAP message defined specifically to convey resources for an MBS session (e.g., MBS Session Resource Setup Response message). In such cases, the CN-to-BS message of event 424 and the BS-to-CN message of event 426 can be non-UE-specific messages.

In some implementations, the CN 110 can indicate, in the CN-to-BS message of event 424, a list of UEs joining the MBS session. In other implementations, the CN 110 can send 430 to the base station 104 a second CN-to-BS message indicating a list of UEs joining the MBS session. The CN 110 can include the MBS session ID and/or the PDU session ID in the second CN-to-BS message. The base station 104 can send 434 a second BS-to-CN message to the CN 110 in response to the second CN-to-BS message 430. In such cases, the second CN-to-BS message and the second BS-to-CN message can be non-UE-specific messages. In this scenario, the list of UEs can include the UE 102A and/or UE 102B. To indicate a list of UEs, the CN 110 can include a list of (CN UE interface ID, RAN UE interface ID) pairs, each identifying a particular UE of the UEs. For example, the list of pairs includes a first pair of (a first CN UE interface ID and a first RAN UE interface ID) identifying the UE 102A and a second pair of (a second CN UE interface ID, a second RAN UE interface ID) identifying the UE 102B. In some implementations, the “CN UE interface ID” can be a “AMF UE NGAP ID” and the “RAN UE interface ID” can be a “RAN UE NGAP ID.” In other implementations, the CN 110 can include a list of UE IDs, each identifying a particular UE in the set of UEs. In some implementations, the CN 110 can assign the UE IDs and send each of the UE IDs to a particular UE of the UEs in a NAS procedure (e.g., registration procedure) that the CN 110 performs with the particular UE. For example, the list of UE IDs can include a first UE ID of the UE 102A and a second UE ID of the UE 102B. In some implementations, the UE IDs are S-Temporary Mobile Subscriber Identities (S-TMSIs) (e.g., 5G-S-TMSIs).

In some alternative implementations, the CN 110 can send 430 to the base station 104 another, second CN-to-BS message indicating that the UE 102 (e.g., a single UE such as UE 102A or UE 102B) joins the first MBS session. The base station 104 can send 434 another, second BS-to-CN message to the CN 110 in response to the second CN-to-BS message of event 430. In such cases, the CN 110 can include the MBS session join response message for the UE 102 in the second CN-to-BS message. The base station 104 can include a first CN UE interface ID and a first RAN UE interface ID, identifying the UE 102, in the second CN-to-BS message. In some implementations, the second CN-to-BS message and the second BS-to-CN message can be UE-specific NGAP messages, such as a PDU Session Resource Modify Request message and a PDU Session Resource Modify Response message, respectively.

In other implementations, the first CN-to-BS message can be a UE-specific NGAP message (e.g., PDU Session Resource Modify Request message) indicating that the UE 102 (e.g., a single UE such as UE 102A or UE 102B) joins the MBS session. The CN 110 can include the MBS session join response message for the UE 102 in the first CN-to-BS message. The base station 104 can include a first CN UE interface ID and a first RAN UE interface ID, identifying the UE 102, in the first CN-to-BS message. In some implementations, the first BS-to-CN message can be a generic NGAP message or a dedicated NGAP message defined specifically to convey resources for an MBS session (e.g., MBS Session Resource Setup Indication message or RAN Configuration Update message). In such cases, the CN 110 can send 430 the second CN-to-BS message (e.g., MBS Session Resource Setup Confirm message or RAN Configuration Update Acknowledge message) to the base station 104 in response to the first BS-to-CN message. Alternatively, the base station 104 can send 434 to the CN 110 a second BS-to-CN message (e.g., PDU Session Resource Modify Response message) in response to the first CN-to-BS message.

In some implementations, the CN 110 can include the MBS session join response message for the UE 102 in another CN-to-BS message instead of the first CN-to-BS message or the second CN-to-BS message.

In some implementations, the QoS configuration(s) include QoS parameters for the MBS session. In some implementations, the QoS configuration(s) includes configuration parameters to configure one or more QoS flows for the MBS session (see FIG. 3 and its description above). In some implementations, the configuration parameters include one or more QoS flow IDs identifying the QoS flow(s). Each of the QoS flow ID(s) identifies a particular QoS flow of the QoS flow(s). In some implementations, the configuration parameters include QoS parameters for each QoS flow. The QoS parameters can include a 5G QoS identifier (5QI), a priority level, packet delay budget, packet error rate, averaging window, and/or a maximum data burst volume. The CN 110 can specify different values of the QoS parameters for the QoS flows.

In cases where the base station 104 establishes the common DL tunnel for the MBS session as described above, the base station 104 may refrain from including a DL transport layer configuration for the MBS session in the second BS-to-CN message. In such cases, the CN 110 may refrain from including a UL transport layer configuration for the MBS session in the first CN-to-BS message and/or second CN-to-BS message.

After or in response to receiving 424 the first CN-to-BS message, receiving 430 the second CN-to-BS message, or transmitting 426 the first BS-to-CN message, the base station 104 generates RRC reconfiguration message(s) (e.g., RRCReconfiguration message(s)) including MBS configuration parameters for the UE 102 to receive MBS data of the MBS session. The base station 104 then transmits 428 the RRC reconfiguration message to the UE 102. In response, the UE 102 transmits 432 an RRC reconfiguration complete message(s) (e.g., RRCReconfigurationComplete message(s)) to the base station 104. The base station 104 can send 434 the second BS-to-CN message to the CN 110 before or after receiving 432 the RRC reconfiguration complete message(s).

In some implementations, the MBS configuration parameters can include one or more MRB configuration and/or one or more RLC bearer configurations each associated with a particular MRB. Each of the MRB configuration(s) can include a (first) MRB ID (e.g., MRB ID 1), a PDCP configuration, the MBS session ID, a PDCP reestablishment indication (e.g., reestablishPDCP), and/or a PDCP recovery indication (e.g., recoveryPDCP). In some implementations, the PDCP configuration can be a PDCP-Config IE for DRB. In some implementations, the RLC bearer configuration can be an RLC-BearerConfig IE. In some implementations, the RLC bearer configuration may include a logical channel (LC) ID configuring a logical channel (e.g., an MBS traffic channel (MTCH)). In some implementations, the configuration parameters or the MRB configuration may include a logical channel configuration (e.g., LogicalChannelConfig IE) configuring the logical channel. In some implementations, the RLC bearer configuration may include the MRB ID. In some implementations, the base station 104 can set the MRB ID to the same value as the DRB ID of event 416. Thus, the UE 102 and base station 104 can associate the MRB with the DRB or the PDU session. In other implementations, the base station 104 can set the MRB ID to a different value from the DRB ID of event 416. As the UE 102 associates the MBS session (ID) with the PDU session (ID), the UE 102 can associate the MRB (ID) with the MBS session (ID) in accordance with the MRB configuration and identify that the MRB (ID) is associated with the DRB (ID).

In some implementations, the UE 102 can perform an MBS session leave procedure with the CN 110 via the base station 104 to leave the MBS session. In the MBS session leave procedure, the UE 102 sends an MBS session leave request message to the CN 110 via the base station 104 to leave the MBS session. In response, the CN 110 sends an MBS session leave response message to the UE 102 via the base station 104. In response to the MBS session leave response message, the UE 102 may send an MBS session leave complete message to the CN 110 via the base station 104. For example, the MBS session leave request message, the MBS session leave response message, and/or the MBS session leave complete message can be SIP messages. In another example, the MBS session leave request message, the MBS session leave response message, and/or the MBS session leave complete message can be a PDU Session Modification Request message, a PDU Session Modification Command message, and a PDU Session Modification Complete message, respectively. In some implementations, the MBS session leave request message, the MBS session leave response message, and/or the MBS session leave complete message can be included in separate container messages as described for the MBS session join procedure 422 above. To simplify the following description, the MBS session leave request message, the MBS session leave response message, and/or the MBS session join complete message can represent their respective container messages. The UE 102 can include the MBS session ID and/or the PDU session ID in the MBS session leave request message. The CN 110 can include the MBS session ID and/or the PDU session ID in the MBS session leave response message to grant the UE 102 to leave the MBS session. In cases where the UE 102 joins the MBS session and other MBS session(s), the UE 102 can include MBS session ID(s) of the other MBS session(s) in the MBS session leave request message. Thus, the UE 102 performs a single MBS session procedure with the CN 110 via the base station 104 to release all the MBS sessions that the UE 102 joins.

In some implementations, the CN 110 initiates releasing the MBS session by transmitting the MBS session leave response message including the MBS session ID to the UE 102 via the base station 104. In response, the UE 102 releases the MBS session and sends the MBS session leave complete message to the CN 110 via the base station 104.

In some implementations, the UE 102 can perform a PDU session release procedure with the CN 110 to simultaneously release the PDU session and all the MBS session(s) associated to the PDU session, without performing an MBS session release procedure. In the PDU session release procedure, the UE 102 can send a PDU Session Release Request message including the PDU session ID to the CN 110 via the base station 104. In response, the CN 110 can send a PDU Session Release Command message to the UE 102. In response to the PDU Session Release Command message, the UE 102 releases the PDU session and all the MBS sessions) and can send a PDU Session Release Complete message to the base station 104. In some implementations, the PDU Session Release Request message, the PDU Session Release Command message, and/or the PDU Session Release Complete message can be included in separate container messages as described above for the PDU session establishment procedure. To simplify the following description, the PDU Session Release Request message, the PDU Session Release Command message, and/or the PDU Session Release Complete message can represent their respective container messages.

In some implementations, the UE 102 may not include the MBS session ID(s) in the PDU Session Release Request message. In other implementations, the UE 102 may include the MBS session ID(s) in the PDU Session Release Request message. The CN 110 may or may not include the PDU session ID and/or MBS session ID(s) in the PDU Session Release Command message. In some implementations, the CN 110 can initiate releasing the PDU session by transmitting the PDU Session Release Command message including the PDU session ID to the UE 102 via the base station 104. In response, the UE 102 releases the PDU session and the MBS session(s) and sends the PDU Session Release Complete message to the CN 110 via the base station 104. In such implementations, the CN 110 may or may not include the MBS session ID(s) in the PDU Session Release Command message.

In some implementations, the base station 104 can configure the MRB as a DL-only RB in the MRB configuration. For example, the base station 104 can refrain from including UL configuration parameters in the PDCP configuration within the MRB configuration to configure the MRB as a DL-only RB. The base station 104 can include only DL configuration parameters in the MRB configuration, e.g., as described above. In such cases, the base station 104 configures the UE 102 to not transmit UL PDCP data PDU(s) via the MRB to the base station 104 by excluding the UL configuration parameters for the MRB in the PDCP configuration in the MRB configuration. In another example, the base station 104 refrains from including UL configuration parameters in the RLC bearer configuration. In such cases, the base station 104 configures the UE 102 not to transmit the control PDU(s) via the logical channel to the base station 104 by excluding the UL configuration parameters from the RLC bearer configuration.

In cases where the base station 104 includes UL configuration parameter(s) in the RLC bearer configuration, the UE 102 may transmit control PDU(s) (e.g., PDCP Control PDU(s) and/or RLC Control PDU(s)) via the logical channel to the base station 104 using the UL configuration parameter(s). For example, the base station 104 may configure the UE 102 to receive MBS data with a (de) compression protocol (e.g., robust header compression (ROHC) protocol). In this case, when the base station 104 receives 436 an MBS data packet from the CN 110, the base station 104 compresses the MBS data packet with the compression protocol to obtain compressed MBS data packet(s) and transmits 438 a PDCP PDU including the compressed MBS data packet to the UE 102. When the UE 102 receives 438 the compressed MBS data packet(s), the UE 102 decompresses the compressed MBS data packet(s) with the (de) compression protocol to obtain the original MBS data packet. In such cases, the UE 102 may transmit a PDCP Control PDU including, a header compression protocol feedback (e.g., interspersed ROHC feedback) for operation of the header (de) compression protocol, via the logical channel to the base station 104.

In some implementations, the MRB configuration can be an MRB-ToAddMod IE including an MRB ID (e.g., mrb-Identity or MRB-Identity). An MRB ID identifies a particular MRB of the MRB(s). The base station 104 sets the MRB IDs to different values. In cases where the base station 104 has configured DRB(s) to the UE 102 for unicast data communication, the base station 104 in some implementations can set the MRB ID(s) to values different from DRB ID(s) of the DRB(s). In such cases, the UE 102 and the base station 104 can distinguish whether an RB is an MRB or a DRB in accordance with an RB ID of the RB. In other implementations, the base station 104 can set one or more of the MRB ID(s) to values which are the same as one or more of the DRB ID(s). In such cases, the UE 102 and the base station 104 can distinguish whether an RB is an MRB or a DRB in accordance with an RB ID of the RB and an RRC IE configuring the RB.

In some implementations, the configuration parameters for receiving MBS data of the first MBS session include one or more logical channel (LC) IDs to configure one or more logical channels. In some implementations, the logical channel(s) can be dedicated traffic channel(s) (DTCH(s)). In other implementations, the logical channel(s) can be multicast traffic channel(s) (MTCH(s)). In some implementations, the configuration parameters might or might not include a group radio network temporary identifier (G-RNTI). The RRC reconfiguration messages for UEs (e.g., the UE 102A and the UE 102B) joining the first MBS session, include the same configuration parameters for receiving MBS data of the first MBS session. In some implementations, the RRC reconfiguration messages for the UEs may include the same or different configuration parameters for receiving non-MBS data.

In some implementations, the base station 104 can include the MBS session join response message in the RRC reconfiguration message the base station 104 transmits 428 to the UE 102. The UE 102 can include the MBS session join complete message in the RRC reconfiguration complete message of event 432. Alternatively, the UE 102 can send a UL RRC message including the MBS session join complete message to the base station 104. The UL RRC message can be a ULInformationTransfer message or any suitable RRC message that can include a UL NAS PDU. The base station 104 can include the MBS session join complete message in the second BS-to-CN message of event 434. Alternatively, the base station 104 can send the CN 110 another BS-to-CN message (e.g., an UPLINK NAS TRANSPORT message) including the MBS session join complete message to the CN 110.

In other implementations, the base station 104 transmits a DL RRC message that includes the MBS session join response message to the UE 102. The DL RRC message can be a DLInformationTransfer message, another RRC reconfiguration message, or any suitable RRC message that can include a DL NAS PDU. The UE 102 can send a UL RRC message including the MBS session join complete message to the base station 104. The UL RRC message can be a ULInformationTransfer message, another RRC reconfiguration complete message, or any suitable RRC message that can include a UL NAS PDU.

After receiving 426 the first BS-to-CN message or receiving 434 the second BS-to-CN message, the CN 110 can send 436 MBS data via the UE-specific DL tunnel and/or the common DL tunnel to the base station 104, which in turn transmits (e.g., multicast or unicast) 438 the MBS data via the MRB or DRB (i.e., via the one or more logical channels associated with the MRB or DRB) to the UE 102. In cases where the CN 110 can send 436 MBS data via the UE-specific DL tunnel to the base station 104, which in turn transmits (e.g., multicast or unicast) 438 the MBS data via the DRB (i.e., via the logical channel associated with the DRB) to the UE 102. In cases where the CN 110 can send 436 MBS data via the common DL tunnel to the base station 104, which in turn transmits (e.g., multicast or unicast) 438 the MBS data via the MRB (i.e., via the logical channel(s) associated with the MRB) to the UE 102.

The UE 102 receives 438 the MBS data via the one or more logical channels. For example, the base station 104 receives 436 an MBS data packet from the CN 110, generates a PDCP PDU including the MBS data packet in accordance with the PDCP configuration within the MRB configuration, generates a MAC PDU including the logical channel ID and the PDCP PDU, and transmits 438 the MAC PDU to the UE 102 via unicast or multicast. The UE 102 receives 438 the MAC PDU, retrieves the PDCP PDU and the logical channel ID from the MAC PDU, identifies the PDCP PDU associated with the MRB or DRB in accordance with the logical channel ID, and retrieves the MBS data packet from the PDCP PDU in accordance with the PDCP configuration within the MRB configuration or DRB configuration. More specifically, if the logical channel ID is associated with the DRB, the UE 102 retrieves the MBS data packet from the PDCP PDU in accordance with the PDCP configuration within the DRB configuration, and if the logical channel ID is associated with the MRB, the UE 102 instead retrieves the MBS data packet from the PDCP PDU in accordance with the PDCP configuration within the MRB configuration.

The events 424, 426, 428, 430, 432, 434, 436, and 438 are collectively referred to in FIG. 4A as an MBS transmission procedure 492.

As illustrated in FIG. 3, the base station 104 can map data packets of a particular MBS session via a particular common DL tunnel to one or more MRBs, each corresponding to a respective logical channel. As described above, the base station 104 at event 426 configures the common DL tunnel, and the base station 104 at event 428 configures the MRB(s) (ID(s)) for the MBS session (ID) and configures the logical channel(s) (ID(s)) for (each of) the MRB(s) (ID(s)). Thus, the base station 104 can map data packets of the MBS session via the common DL tunnel to the MRB(s), each corresponding to a respective logical channel.

Referring next to FIG. 4B, a scenario 400B is depicted which is generally similar to the scenario 400A. Events in scenario 400B similar to those discussed above for scenario 400A are labeled with the same reference numbers, and the examples and implementations for FIG. 4A can apply to FIG. 4B. The differences between the scenarios of FIG. 4A and FIG. 4B are discussed below.

In some implementations, the CN 110 may or may not transmit 424 the CN-to-BS message, e.g., in response to or after receiving the MBS session join request message of the MBS session join procedure 422. In cases where the CN 110 transmits 424 the CN-to-BS message to the base station 104, the base station 104 can transmit 429 to the UE 102 an RRC reconfiguration message including unicast configuration parameters (instead of the MBS configuration parameters at event 428). In such cases, the base station 104 may not configure a common DL tunnel for the MBS session. In some implementations, the base station 104 can include, in the BS-to-CN message of event 434, a DL transport layer configuration configuring a UE-specific DL tunnel. The DL transport layer configuration can include a transport layer address (e.g., IP address) and/or a TEID to identify the UE-specific DL tunnel. In such cases, the CN 110 may or may not include, in the CN-to-BS message 424, a UL transport layer configuration configuring a UE-specific UL tunnel.

In some implementations, the base station 104 can generate the unicast configuration parameters included in the message of event 429, to update the unicast configuration parameters of event 416, and/or to configure another (second) DRB.

In some implementations, the unicast configuration parameters can include a (second) DRB configuration (e.g., a DRB-ToAddMod IE) and first lower layer configuration(s). The DRB configuration configures the (second) DRB. The DRB configuration includes a (second) DRB ID (e.g., drb-Identity or DRB-Identity) identifying the DRB, and includes the PDU session ID to indicate that the DRB (ID) associated with the PDU session (ID). The DRB configuration can also include a PDCP configuration and/or an SDAP configuration.

In some implementations, the (second) lower layer configuration(s) are associated with the DRB configuration. The lower layer configuration(s) include a (second) logical channel identity (ID) (e.g., LogicalChannelIdentity IE) identifying a logical channel (e.g., a DTCH), a RLC configuration (e.g., RLC-Config IE), and/or a logical channel configuration (e.g., LogicalChannelConfig IE). In some implementations, the base station 104 can exclude the logical channel configuration from the RRC reconfiguration message 416. In some implementations, the lower layer configuration can be or include an RLC bearer configuration (e.g., RLC-BearerConfig IE), which can include the DRB ID, the logical channel ID, the RLC configuration, and/or the logical channel configuration. In some implementations, the lower configuration can be a cell group configuration (e.g., CellGroupConfig IE). In some implementations, the lower layer configuration includes a MAC configuration (e.g., MAC-CellGroupConfig IE) or a physical layer configuration (e.g., PhysicalCellGroupConfig IE).

In some implementations, (some of) the unicast configuration parameters of the event 429 and (some of) the unicast configuration parameters of the event 428 may have the same values. In other implementations, (some of) the unicast configuration parameters of the event 429 and (some of) the unicast configuration parameters of the event 428 may have different values.

Alternatively, the base station 104 refrains from transmitting 429 the RRC reconfiguration message to the UE 102 and the event 432 is omitted.

After receiving 434 the BS-to-CN message, the CN 110 can send 437 MBS data via the UE-specific DL tunnel (i.e., configured in the BS-to-CN message 434) to the base station 104, which in turn transmits 439 the MBS data to the UE 102 via the second DRB (i.e., via the logical channel associated with the second DRB). After receiving 434 the BS-to-CN message or the MBS session join procedure 422, the CN 110 can send 437 MBS data via the UE-specific DL tunnel (i.e., configured in the event 420) to the base station 104, which in turn transmits (i.e., unicast) 439 the MBS data via the first DRB (i.e., via the logical channel associated with the first DRB).

As illustrated in FIG. 3, the base station 104 can map data packets of a particular MBS session via a particular UE-specific DL tunnel to one or more DRBs, each corresponding to a respective logical channel. As described above, the base station 104 at event 434 configures the UE-specific DL tunnel, and the base station 104 at events 490, 429 configures the DRB(s) (ID(s)) for the MBS session (ID) and configures the logical channel(s) (ID(s)) for (each of) the DRB(s) (ID(s)). Thus, the base station 104 can map data packets of the MBS session via the UE-specific DL tunnel to the first DRB and/or second DRB, each corresponding to a respective logical channel.

The events 424, 429, 434, 437, and 439 are collectively referred to in FIG. 4B as an MBS transmission procedure 496.

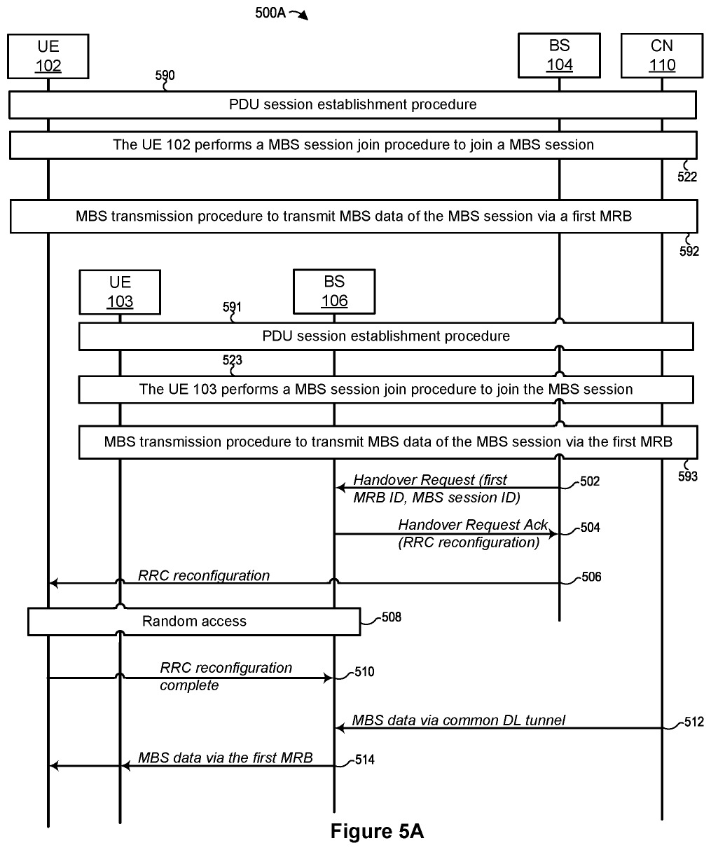

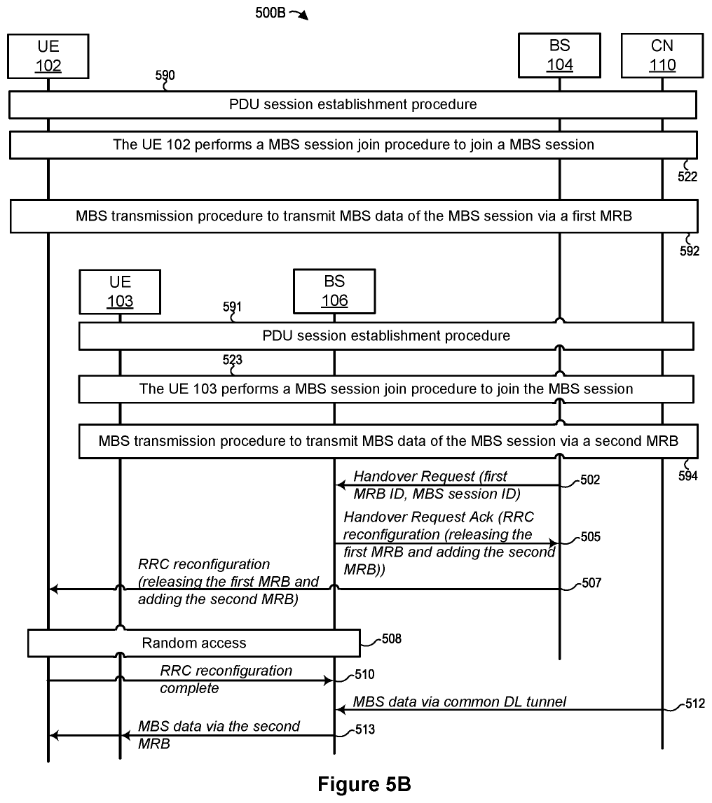

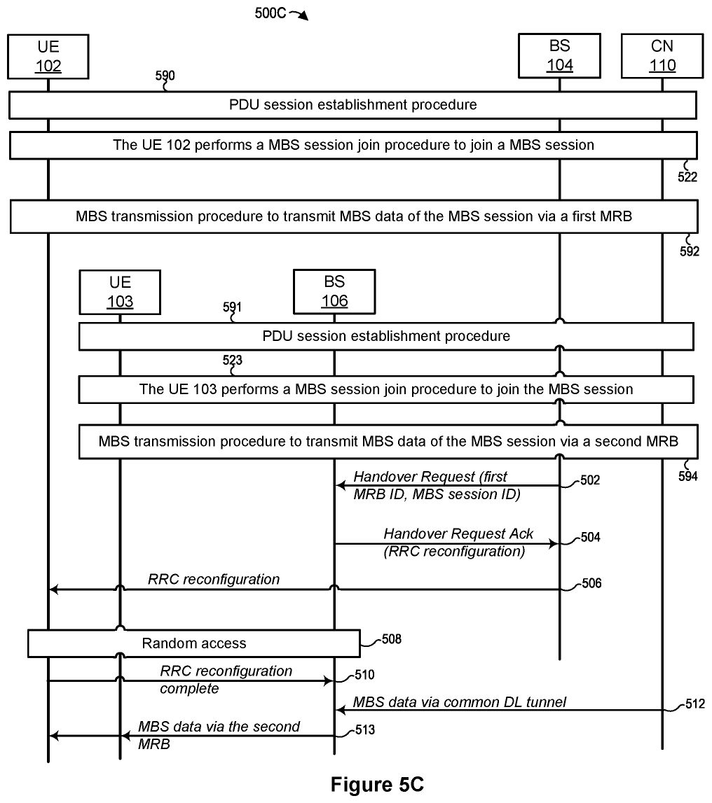

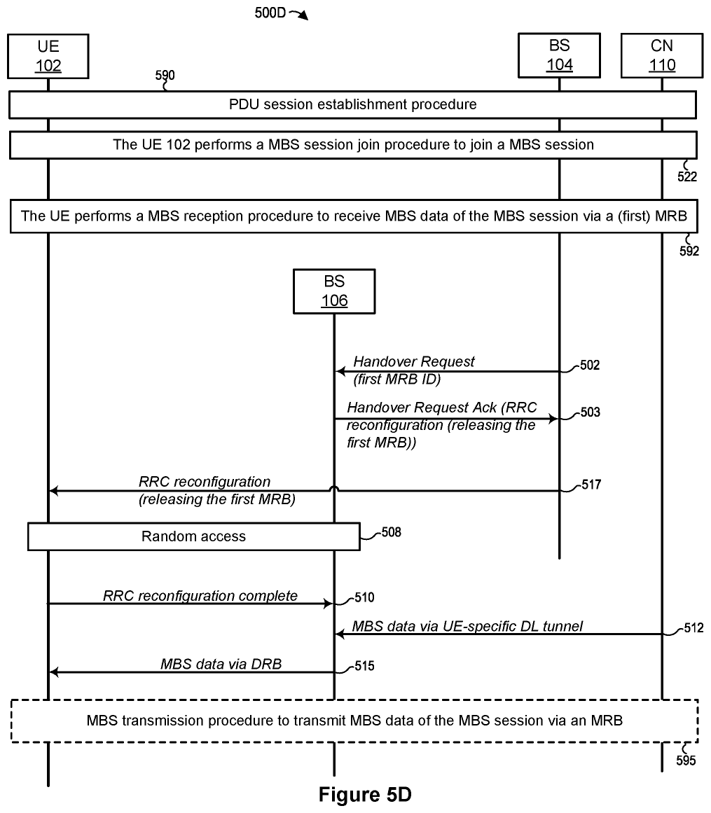

Next, FIG. 5A illustrates an example scenario 500A in which the base station (BS) 104 transmits (i.e., multicast) MBS data to the UE 102 via a first MRB and later hands over the UE 102 to BS 106. In the following description, the UE 102 can represent the UE 102A and/or the UE 102B.

Initially, the UE 102 performs a PDU session establishment procedure 590 with the CN 110 via the BS 104, similar to the event 490. The UE 102 performs an MBS session join procedure 522 with the CN 110 via the BS 104 to join an MBS session, similar to the event 422. After the event 522, the CN 110 can perform an MBS transmission procedure 592 with the BS 104 and UE 102, where the CN 110 can transmit MBS data of the MBS session to the BS 104 which in turn transmits the MBS data to the UE 102 via a first MRB (identified by a first MRB ID), similar to the event 492.

Similarly, the UE 103 performs a PDU session establishment procedure 591 with the CN 110 via the BS 106, similar to the event 490. The UE 103 performs an MBS session join procedure 523 with the CN 110 via the BS 106 to join an MBS session (identified by a MBS session ID), similar to the event 422. After the event 523, the CN 110 can perform an MBS transmission procedure 593 with the BS 106 and UE 102, where the CN 110 can transmit MBS data of the MBS session to the BS 106 which in turn transmits the MBS data to the UE 102 via the first MRB, similar to the event 492.

Later in time, the BS 104 determines to hand over the UE 102 to the BS 106. In response to the determination, the BS 104 sends 502 a Handover Request message including the first MRB ID and the MBS session ID to the BS 106. The BS 104 can include the PDU session ID and/or a DRB ID in the Handover Request message. The DRB ID identifying a DRB for the UE 102 is configured in the procedure 590. In some implementations, the BS 104 can include an MRB configuration of the first MRB in the Handover Request message. Because the BS 106 has configured the first MRB (ID) for the MBS session (ID), the BS 106 may refrain from reconfiguring the first MRB for the UE 102. In response to the Handover Request message, the BS 106 sends 504 to the BS 104 a Handover Request Acknowledge message including an RRC reconfiguration message to hand over the UE 102 to the BS 106. In turn, the BS 104 retrieves the RRC reconfiguration message from the Handover Request Acknowledge message and transmits 506 the RRC reconfiguration message to the UE 102. In response to or after receiving the RRC reconfiguration message, the UE 102 performs a random access procedure 508 with the BS 106 via cell 126. The UE 102 can transmit 510 an RRC reconfiguration complete message to the BS 106 during or after the random access procedure 508.

In some implementations, the BS 106 can indicate the first MRB and DRB are handed over to the BS 106 in the RRC reconfiguration message.

After the BS 106 detects that the UE 102 successfully connects to the BS 106 via cell 126, the BS 106 can send a Path Switch Request message to the CN 110 to indicate to the CN 110 that the UE 102 has connected to the BS 106. In response, the CN 110 can send a Path Switch Request Acknowledge message to the BS 106. After the UE 102 successfully hands over to the BS 106, the BS 106 receives 512 MBS data via the common DL tunnel (established during the procedure 593). The BS 106 then transmits 514 the MBS data to the UE 102 and UE 103 via multicast and the first MRB (e.g., a logical channel (ID), an RLC configuration, and/or a PDCP configuration associated with the first MRB).

In cases where the BS 104 and BS 106 use different G-RNTIs (e.g., first G-RNTI and second G-RNTI used by the BS 104 and BS 106 respectively) to schedule transmissions of MBS data of the MBS session, the BS 106 can include the second G-RNTI in the RRC reconfiguration message to replace the first G-RNTI. When the UE 102 receives the second G-RNTI in the RRC reconfiguration message, the UE 102 replaces the first G-RNTI with the second G-RNTI.

In some implementations, the BS 104 can perform a handover preparation involving the CN 110 instead of the handover preparation without involving the CN 110 (i.e., instead of events 502, 504). In the handover preparation involving the CN 110, the BS 104 sends to the CN 110 a Handover Required message including the first MRB ID and the MBS session ID. In response to or after receiving the Handover Required message, the CN 110 can send a Handover Request message (e.g., a NGAP message) including the first MRB ID and MBS session ID to the BS 106. In some implementations, the BS 104 can include the DRB ID and the PDU session ID in the Handover Required message and the CN 110 can include the DRB ID and the PDU session ID in the Handover Request message. In response to or after receiving the Handover Request message from the CN 110, the BS 106 can send a Handover Request Acknowledge message (e.g., a NGAP message) including the RRC reconfiguration message to the CN 110, which is similar to the Handover Request Acknowledge message 504. Then, the CN 110 can send a Handover Command message (e.g., a NGAP message) including the RRV reconfiguration message to the BS 104.

Referring next to FIG. 5B, a scenario 500B is depicted which is generally similar to the scenario 500A. Events in scenario 500B similar to those discussed above for scenario 500A are labeled with the same reference numbers, and the examples and implementations for FIG. 5A can apply to FIG. 5B. The differences between the scenarios of FIG. 5A and FIG. 5B are discussed below.

After the event 523, the CN 110 can perform an MBS transmission procedure 594 with the BS 106 and UE 102, instead of the MBS transmission procedure 593. In the procedure 594, the BS 106 configures a second MRB, identified by a second MRB ID, for the MBS session. During the MBS transmission procedure 594, the CN 110 can transmit MBS data of the MBS session to the BS 106, which in turn transmits the MBS data to the UE 102 via the second MRB, similar to the event 492.

When the BS 106 receives 502 the first MRB ID, the BS 106 identifies that BS 106 does not configure the first MRB ID for the MBS session (ID). In response to the identification, the BS 106 can generate an RRC reconfiguration message to indicate releasing the first MRB and adding the second MRB. For example, the BS 106 can generate an MRB release configuration (e.g., MRB-ToRelease IE or MRB-ToReleaseList IE) including the first MRB ID to indicate releasing the first MRB, and generate an MRB configuration (e.g., MRB-ToAddMod IE) to configure the second MRB. The BS 106 can include the MRB release configuration and the MRB configuration in the RRC reconfiguration message. The BS 106 then transmits 505 a Handover Request Acknowledge message including the RRC reconfiguration message to the BS 104. In turn, the BS 104 transmits 507 the RRC reconfiguration message to the UE 102.

The UE 102 releases the first MRB and adds the second MRB in response to or after receiving the RRC reconfiguration message. More specifically, the UE 102 releases the first MRB in response to the MRB release configuration and adds (i.e., configures) the second MRB in accordance with the MRB configuration. After event 512, the BS 106 transmits 513 the MBS data to the UE 102 and UE 103 via multicast and the second MRB (e.g., a logical channel, a RLC configuration and/or a PDCP configuration associated with the second MRB).

Referring next to FIG. 5C, a scenario 500C is depicted which is generally similar to the scenarios 500A and 500B. Events in scenario 500C similar to those discussed above in scenario 500A and/or scenario 500B are labeled with the same reference numbers, and the examples and implementations for FIGS. 5A-5B can apply to FIG. 5C. The differences among the scenarios of FIGS. 5A-5C are discussed below.

After receiving 502 the Handover Request message, the BS 106 refrains from releasing the first MRB and configuring the second MRB for the UE 102. In cases where configuration(s) (e.g., a logical channel (ID), a RLC configuration, and/or a PDCP configuration) associated with the first MRB is/are different from configuration(s) (e.g., a logical channel (ID), a RLC configuration and/or a PDCP configuration) associated with the second MRB, the BS 106 can include the configuration(s) associated with the second MRB in the RRC reconfiguration message. Thus, the UE 102 applies the configuration(s) associated with the second MRB to receive 513 the MBS data via the second MRB. The BS 106 does not, however, change the first MRB ID to the second MRB ID in the RRC reconfiguration message.

Referring next to FIG. 5D, a scenario 500D is depicted which is generally similar to the scenarios 500A, 500B, and 500C. Events in scenario 500D similar to those discussed above for scenarios 500A, 500B, and/or 500C are labeled with the same reference numbers, and the examples and implementations for FIGS. 5A-5C can apply to FIG. 5D. The differences among the scenarios of FIGS. 5A-5D are discussed below.

After receiving 502 the Handover Request message, the BS 106 determines to release the first MRB because the BS 106 has not configured an MRB and/or resources (e.g., common DL tunnel) for the MBS session. In response to the determination, the BS 106 indicates to release the first MRB in an RRC reconfiguration message for handover, as described for FIG. 5B. The BS 106 then transmit 503 a Handover Request Acknowledge message including the RRC reconfiguration message to the BS 104. In turn, the BS 104 transmits 517 the RRC reconfiguration message to the UE 102. After the UE 102 successfully hands over to the BS 106, the BS 106 receives 512 MBS data via the common DL tunnel (established during the procedure 593). The BS 106 then transmits 515 the MBS data to the UE 102 via unicast and a DRB (e.g., a logical channel, an RLC (bearer) configuration, and/or a PDCP configuration associated with the DRB). In some implementations, the UE 102 receives from the BS 104 a DRB configuration configuring the DRB during the procedure 590, similar to the procedure 490 or the event 416. In such cases, the BS 106 indicates to the UE 102 that the DRB is handed over to the BS 106. The BS 106 can include configuration parameters in the RRC reconfiguration message 503, 517 to reconfigure the DRB configuration or configuration(s) associated to the DRB. In other implementations, the RRC reconfiguration message includes a (new) DRB configuration configuring the DRB (i.e., a new DRB). In such cases, the BS 106 generates the DRB configuration and configuration(s) associated to the DRB to configure the DRB. In some implementations, the configuration(s) includes the RLC (bearer) configuration (e.g., RLC-BearerConfig IE or RLC-Config IE) and/or a logical channel ID identifying the logical channel.

Later in time, the BS 106 can perform MBS transmission procedure 595 to transmit MBS data of the MBS session via an MRB, similar to the procedure 492.

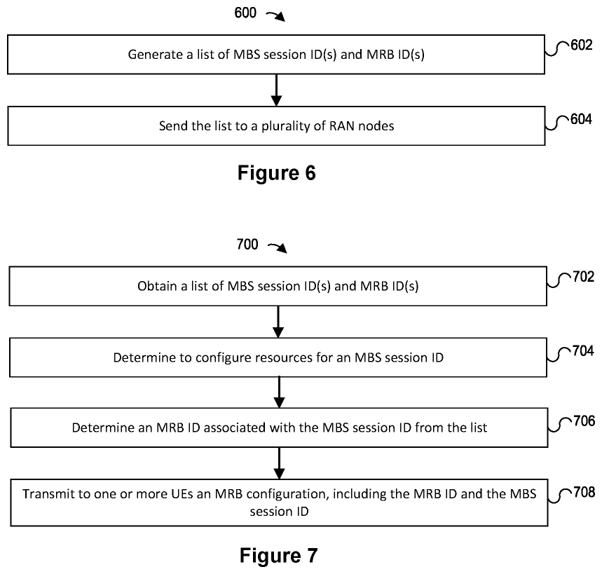

Next, several example scenarios, which can be implemented/performed by devices illustrated in FIGS. 1A, are discussed with reference to FIGS. 6-12. Each of these methods can be implemented by one or more processors executing a set of instructions stored on a non-transitory computer-readable medium. Blocks with dashed line can be optional.

Referring first to FIG. 6, a network node such as the CN 110, AMF 164, or an OAM node can implement/perform a method 600 to receive MBS data. The method 600 begins at block 602, where the network node generates a list of MBS session ID(s) and MRB ID(s). At block 604, the network node sends the list to a plurality of RAN nodes (e.g., CUs and/or base stations). Each of the MRB ID(s) corresponds to a particular MBS session ID. The list can be a mapping table.

| | |
|---|---|
| MBS session ID 1 | MRB ID 1 |
| MBS session ID 2 | MRB ID 2 |
| . . . | . . . |
| MBS session ID N (N >= 1) | MRB ID N |

In some implementations, the network node (e.g., OAM or CN) sends message(s) including the list to the plurality of RAN nodes. Thus, the plurality of RAN nodes uses the same MRB ID associated with the same MBS session ID.

Referring next to FIG. 7, a RAN node such as the CU 172 or base station 104/106 can implement/perform a method 700 to determine an MRB ID.

The method 700 begins at block 702, where the RAN node obtains a list of MBS session ID(s) and MRB ID(s). At block 704, the RAN node determines to configure resources for an MBS session ID. For example, the RAN node may receive from a CN a CN-to-BS message including the MBS session ID to request resources for the MBS session ID. At block 706, the RAN node determines (e.g., selects or identifies) an MRB ID for the MBS session ID from the list (e.g., the mapping table). For example, if the MBS session ID is MBS session ID 2, then the RAN node determines the MRB ID 2 for MBS session ID 2 in accordance with the mapping table. At block 708, the RAN node transmits an MRB configuration, including the MRB ID and the MBS session ID, to one or more UEs.

In some implementations, the RAN node receives the list of MBS session ID(s) and MRB ID(s) from a network node (e.g., CN or OAM). In other implementations, the RAN node is preconfigured to store the list of MBS session ID(s) and MRB ID(s).

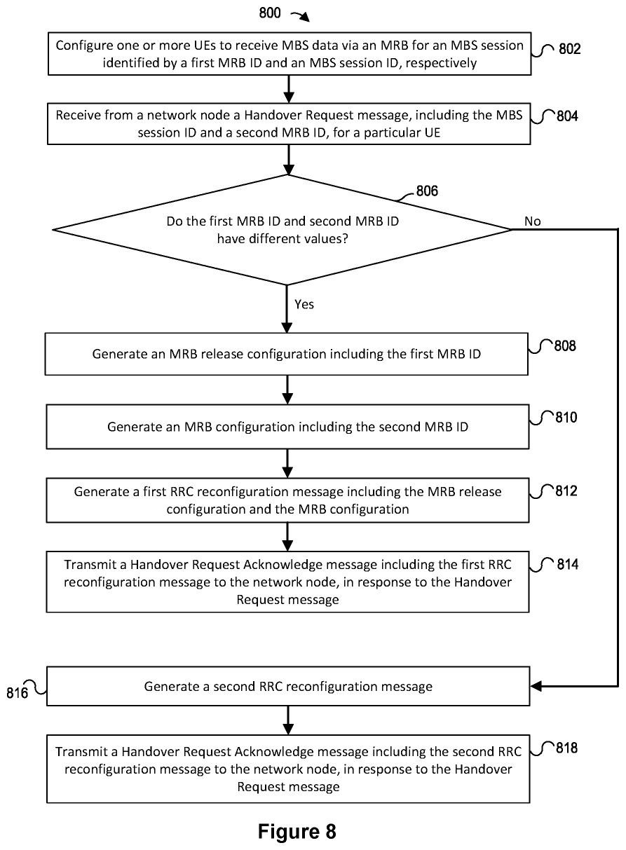

Referring next to FIG. 8, a RAN node such as the CU 172 or base station 104/106 can implement/perform a method 800 to release or configure an MRB in a handover preparation.

At block 802, the RAN node configures one or more UEs to receive MBS data via an MRB for an MBS session identified by a first MRB ID and a MBS session ID, respectively. At block 804, the RAN node receives from a network node (e.g., another RAN node such as a base station or a CU, or a CN node such as a AMF) a Handover Request message, including the MBS session ID and a second MRB ID, for a particular UE. At block 806, the RAN node determines whether the first MRB ID and second MRB ID have different values. If the first MRB ID and second MRB ID have different values, the flow proceeds to block 808. At block 808, the RAN node generates an MRB release configuration including the first MRB ID. At block 810, the RAN node generates an MRB configuration including the second MRB ID. At block 812, the RAN node generates a first RRC reconfiguration message including the MRB release configuration and the MRB configuration. At block 814, the RAN node transmits a Handover Request Acknowledge message including the first RRC reconfiguration message to the network node, in response to the Handover Request message.

If the first MRB ID and the second MRB ID have the same values, the flow proceeds instead to block 816. At block 816, the RAN node generates a second RRC reconfiguration message. At block 818, the RAN node transmits a Handover Request Acknowledge message including the second RRC reconfiguration message to the network node, in response to the Handover Request message.

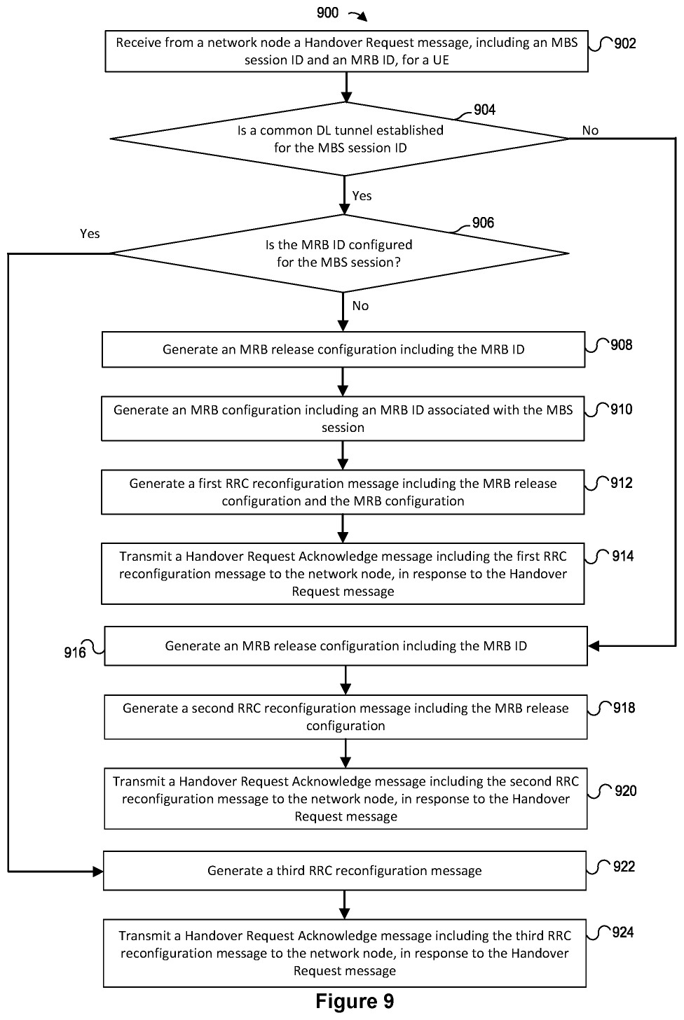

Referring next to FIG. 9, a RAN node such as the CU 172 or base station 104/106 can implement/perform a method 900 to release or configure an MRB in a handover preparation.

At block 902, the RAN node receives from a network node (e.g., another RAN node such as a base station or a CU, or a CN node such as a AMF) a Handover Request message, including an MBS session ID and an MRB ID, for a UE. At block 904, the RAN node determines whether a common DL tunnel has been established for the MBS session ID. If the RAN node has established a common DL tunnel for the MBS session ID, the flow proceeds to block 906. At block 906, the RAN node determines whether the RAN node has configured the MRB ID for the MBS session. If the RAN node has not configured the MRB ID for the MBS session, the flow proceeds to block 908. At block 908, the RAN node generates an MRB release configuration including the MRB ID to release an MRB. At block 910, the RAN node generates an MRB configuration including an MRB ID associated with the MBS session. For example, the RAN node can include the MBS session ID in the MRB configuration. In some implementations, an MRB identified by the MRB ID in the MRB configuration is associated with the common DL tunnel as described for FIG. 3. At block 912, the RAN node generates a first RRC reconfiguration message including the MRB release configuration and the MRB configuration. At block 914, the RAN node transmits a Handover Request Acknowledge message including the first RRC reconfiguration message to the network node, in response to the Handover Request message.

If the RAN node has not established a common DL tunnel for the MBS session ID, the flow proceeds instead to block 916. At block 916, the RAN node generates an MRB release configuration including the MRB ID to release an MRB. At block 918, the RAN node generates a second RRC reconfiguration message including the MRB release configuration. At block 920, the RAN node transmits a Handover Request Acknowledge message including the second RRC reconfiguration message to the network node, in response to the Handover Request message.

If the RAN node has configured the MRB ID for the MBS session, the flow proceeds to block 922. At block 922, the RAN node generates a third RRC reconfiguration message, and at block 924, the RAN node transmits a Handover Request Acknowledge message including the third RRC reconfiguration message to the network node, in response to the Handover Request message.

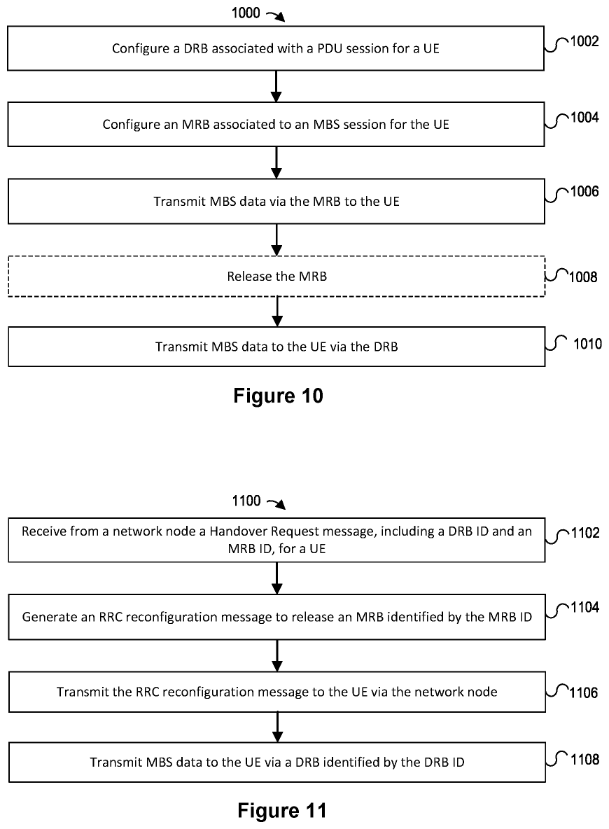

Referring next to FIG. 10, a RAN node such as the CU 172 or base station 104/106 can implement/perform a method 1000 to transmit MBS data via an MRB and/or a DRB.

At block 1002, the RAN node configures a DRB associated to a PDU session for a UE. At block 1004, the RAN node configures a MRB associated with a MBS session for the UE. At block 1006, the RAN node transmits MBS data via the MRB to the UE. At block 1008, the RAN node releases the MRB. At block 1010, the RAN node transmits MBS data to the UE via the DRB, e.g., after releasing the MRB.

Referring next to FIG. 11, a RAN node such as the CU 172 or base station 104/106 can implement/perform a method 1100 to release an MRB and transmit MBS data via a DRB.

At block 1102, the RAN node receives from a network node a Handover Request message, including a DRB ID and a MRB ID, for a UE. At block 1104, the RAN node generates a RRC reconfiguration message to release a MRB identified by the MRB ID. At block 1106, the RAN node transmits the RRC reconfiguration message to the UE via the network node. At block 1108, the RAN node transmits MBS data to the UE via a DRB identified by the DRB ID.

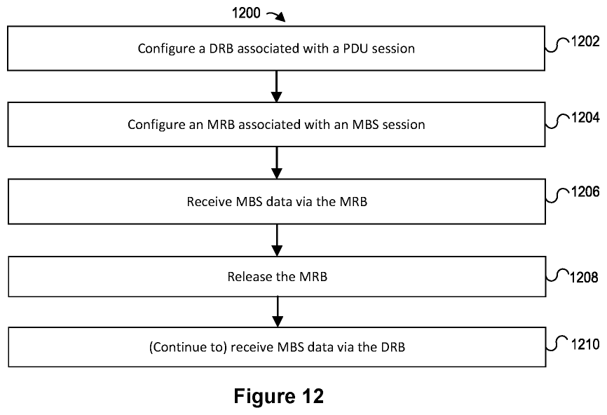

Referring next to FIG. 12, a UE such as the UE 102 can implement/perform a method 1200 to receive MBS data via an MRB or a DRB.

At block 1202, the UE configures a DRB associated with a PDU session. At block 1204, the UE configures a MRB associated with an MBS session. At block 1206, the UE receives MBS data via the MRB. At block 1208, the UE releases the MRB. At block 1210, the UE (continues to) receive MBS data via the DRB, e.g., after releasing the MRB.

The following list of examples reflects a variety of the implementations explicitly contemplated by the present disclosure:

Example 1. A method, performed by a radio access network (RAN) node, of managing multicast and/or broadcast services (MBS) communications, the method comprising: receiving, from a network node, a handover request message including a first MBS radio bearer (MRB) identifier associated with a first MRB for an MBS session; transmitting, to the network node, a handover request acknowledge message including a radio resource control (RRC) reconfiguration message, the RRC reconfiguration message indicating that a user equipment (UE) is to release the first MRB and add a second MRB associated with a second MRB identifier; and transmitting MBS data of the MBS session to the UE.

Example 2. The method of example 1, further comprising, before receiving the handover request message: performing an MBS session join procedure with a core network (CN) for an other user equipment (UE) to join the MBS session; and transmitting other MBS data of the MBS session to the other UE via the second MRB.

Example 3. The method of example 2, further comprising, after transmitting the handover request acknowledge message and before transmitting the MBS data to the UE: performing a random access procedure with the UE.

Example 4. The method of any one of examples 1-3, wherein the RRC reconfiguration message includes an MRB release configuration including the first MRB identifier and an MRB configuration including the second MRB identifier.

Example 5. The method of any one of examples 1-4, further comprising, after receiving the handover request message: determining that the first MRB identifier and the second MRB identifier have different values; based on the determining, generating the RRC reconfiguration indicating that the UE is to release the first MRB and add the second MRB.

Example 6. The method of any one of examples 1-5, wherein the RAN node is a target base station and the network node is a source base station.

Example 7. The method of any one of examples 1-5, wherein the RAN node is a target base station and the network node is a core network (CN).

Example 8. A method, performed by a network node, of managing multicast and/or broadcast services (MBS) communications, the method comprising:
transmitting, to a radio access network (RAN) node, a handover request message including a first MBS radio bearer (MRB) identifier associated with a first MRB for an MBS session; receiving, from the RAN node, a handover request acknowledge message including a radio resource control (RRC) reconfiguration message, the RRC reconfiguration message indicating that a user equipment (UE) is to release the first MRB and add a second MRB associated with a second MRB identifier; and transmitting the RRC reconfiguration message to the UE.

Example 9. The method of example 8, further comprising, before transmitting the handover request message: performing an MBS session join procedure with a core network (CN) for the UE to join the MBS session; and transmitting MBS data of the MBS session to the UE via the first MRB.

Example 10. The method of example 8 or 9, wherein the network node is a source base station and the RAN node is a target base station.

Example 11. The method of any one of examples 8-10, wherein the first MRB identifier is different from the second MRB identifier.

Example 12. The method of any one of examples 8-11, wherein the RRC reconfiguration message includes an MRB release configuration including the first MRB identifier and an MRB configuration including the second MRB identifier.

Example 13. A network node configured to perform the method of any one of examples 1-12.

Example 14. A method, performed by a user equipment (UE), of managing multicast and/or broadcast services (MBS) communications, the method comprising: receiving MBS data of an MBS session from a first radio access network (RAN) node via a first MBS radio bearer (MRB); receiving, from the first RAN node, a radio resource control (RRC) message; based on the RRC message, releasing the first MRB and adding a second MRB; and receiving other MBS data of the MBS session from a second RAN node via the second MRB.

Example 15. The method of example 14, further comprising, before receiving the MBS data: performing an MBS session join procedure with the first RAN node to join the MBS session.

Example 16. The method of example 14 or 15, wherein the first MRB is associated with a first MRB identifier and the second MRB is associated with a second MRB identifier different from the first MRB identifier.

Example 17. The method of example 15, wherein the RRC reconfiguration message includes an MRB release configuration including the first MRB identifier and an MRB configuration including the second MRB identifier.

Example 18. The method of any one of examples 14-17, further comprising, after receiving the RRC reconfiguration message and before receiving the other MBS data: performing a random access procedure with the second RAN node.

Example 19. A user equipment (UE) configured to perform the method of any one of examples 14-18.

Example 20. A method, performed by a radio access network (RAN) node, of managing multicast and/or broadcast services (MBS) communications, the method comprising: configuring, for a user equipment (UE), a data radio bearer (DRB) associated with a protocol data unit (PDU) session; configuring, for the UE, an MBS radio bearer (MRB) associated with an MBS session; transmitting MBS data to the UE via the MRB; releasing the MRB; and after the releasing, transmitting other MBS data to the UE via the DRB.

Example 21. The method of example 20, wherein the RAN node is a base station.

Example 22. A RAN node configured to perform the method of example 20 or 21.

Example 23. A method, performed by a radio access network (RAN) node, of managing multicast and/or broadcast services (MBS) communications, the method comprising: receiving, from a network node, a handover request message including a first MBS radio bearer (MRB) identifier for a user equipment (UE), the first MRB identifier being associated with a first MRB of an MBS session, and an MBS session identifier being associated with the MBS session; generating a radio resource control (RRC) reconfiguration message that includes or does not include an MRB release configuration including the first MRB identifier based on one or both of (i) whether the RAN node has or has not configured the first MRB ID for the MBS session, and (ii) whether the RAN node has or has not established a common downlink tunnel for the MBS session identifier; and transmitting, to the network node, a handover request acknowledge message including the RRC reconfiguration message.

Example 24. The method of example 23, comprising: generating an RRC reconfiguration message that includes the MRB release configuration including the first MRB identifier when the RAN node has not configured the first MRB ID for the MBS session.

Example 25. The method of example 24, further comprising: before receiving the handover request message, configuring one or more UEs to receive MBS data via a second MRB associated with a second MRB identifier; and determining that the first MRB identifier and the second MRB identifier have different values, wherein generating the RRC reconfiguration message that includes the MRB release configuration including the first MRB identifier is based on the determining.

Example 26. The method of example 25, comprising: generating an RRC reconfiguration message that includes (i) the MRB release configuration including the first MRB identifier, and (ii) an MRB configuration including the second MRB identifier, when the RAN node has not configured the first MRB ID for the MBS session.

Example 27. The method of example 23, comprising: generating an RRC reconfiguration message that does not include the MRB release configuration including the first MRB identifier when the RAN node has configured the first MRB ID for the MBS session.

Example 28. The method of example 27, further comprising: before receiving the handover request message, configuring one or more UEs to receive MBS data via a second MRB associated with a second MRB identifier; and determining that the first MRB identifier and the second MRB identifier have a same value, wherein generating the RRC reconfiguration message that does not include the MRB release configuration including the first MRB identifier is based on the determining.

Example 29. The method of example 23, comprising: generating an RRC reconfiguration message that includes the MRB release configuration including the first MRB identifier when the RAN node has not established a common downlink tunnel for the MBS session identifier.

Example 30. The method of example 23, comprising: generating an RRC reconfiguration message that includes the MRB release configuration including the first MRB identifier when the RAN node has established a common downlink tunnel for the MBS session identifier and the RAN node has not configured the first MRB ID for the MBS session.

Example 31. The method of example 30, comprising: generating an RRC reconfiguration message that includes (i) the MRB release configuration including the first MRB identifier, and (ii) an MRB configuration including a second MRB identifier associated with a second MRB, when the RAN node has established a common downlink tunnel for the MBS session identifier and the RAN node has not configured the first MRB ID for the MBS session.

Example 32. The method of example 23, comprising: generating an RRC reconfiguration message that does not include the MRB release configuration including the first MRB identifier when the RAN node has established a common downlink tunnel for the MBS session identifier and the RAN node has configured the first MRB ID for the MBS session.

Example 33. The method of any one of examples 23-32, wherein the RAN node is a target base station for a handover and the network node is a source base station for the handover.

Example 34. The method of any one of examples 23-32, wherein the RAN node is a target base station for a handover and the network node is a core network (CN) node.

Example 35. A method, performed by a radio access network (RAN) node, of managing multicast and/or broadcast services (MBS) communications, the method comprising: receiving, from a network node and without the RAN node having previously configured a first MBS radio bearer (MRB) identifier for an MBS session, a handover request message including the first MRB identifier, wherein the first MRB identifier is associated with a first MRB of the MBS session; generating a radio resource control (RRC) reconfiguration message that omits an MRB release configuration including the first MRB identifier; and transmitting, to the network node, a handover request acknowledge message including the RRC reconfiguration message.

Example 36. The method of example 35, further comprising: before receiving the handover request message, transmitting MBS data to a user equipment (UE) via a second MRB of the MBS session, the second MRB being associated with a second MRB identifier different from the first MRB identifier.

Example 37. The method of example 36, further comprising: after transmitting the handover request acknowledge message, transmitting MBS data to an other UE via the second MRB.

Example 38. The method of any one of examples 35-37, wherein the RAN node is a target base station for a handover and the network node is a source base station for the handover.

Example 39. The method of any one of examples 35-37, wherein the RAN node is a target base station for a handover and the network node is a core network (CN) node.

Example 40. A method, performed by a radio access network (RAN) node, of managing multicast and/or broadcast services (MBS) communications, the method comprising: receiving, from a network node, a handover request message including a data radio bearer (DRB) identifier and an MBS radio bearer (MRB) identifier; generating a radio resource control (RRC) reconfiguration message including an MRB release configuration that includes the MRB identifier; transmitting the RRC reconfiguration message to a user equipment (UE) via the network node; and transmitting MBS data to the UE via a DRB associated with the DRB identifier.

Example 41. The method of example 40, wherein transmitting the RRC reconfiguration message to the UE via the network node includes transmitting a handover request acknowledge message including the RRC reconfiguration message to the network node.

Example 42. The method of example 40 or 41, wherein the RAN node is a target base station for a handover and the network node is a source base station for the handover.

Example 43. The method of example 40 or 41, wherein the RAN node is a target base station for a handover and the network node is a core network (CN) node.

Example 44. A radio access network (RAN) node configured to perform the method of any one of examples 23-43.

Example 45. A method, performed by a network node, of managing multicast and/or broadcast services (MBS) information, the method comprising: generating a list of one or more MBS session identifiers and one or more MBS radio bearer (MRB) identifiers, with each of the one or more MBS session identifiers corresponding to a particular one of the one or more MRB identifiers; and transmitting the list to a plurality of radio access network (RAN) nodes.

Example 46. The method of example 45, wherein the network node is a core network node.

Example 47. The method of example 45, wherein the network node is an Operations, Administration and Maintenance (OAM) node.

Example 48. The method of any one of examples 45-47, wherein the plurality of RAN nodes includes a plurality of base stations.

Example 49. The method of any one of examples 45-47, wherein the plurality of RAN nodes includes a plurality of central units (CUs) of distributed base stations.

Example 50. The method of any one of examples 45-47, wherein the list is a mapping table.

Example 51. A network node configured to perform the method of any one of examples 45-50.

Example 52. A method, performed by a radio access network (RAN) node, of determining a multicast and/or broadcast services (MBS) radio bearer (MRB) identifier, the method comprising: obtaining a list of one or more MBS session identifiers and one or more MRB identifiers, with each of the one or more MBS session identifiers corresponding to a particular one of the one or more MRB identifiers; determining to configure resources for a particular MBS session identifier; determining, based on the list, a particular MRB identifier associated with the particular MBS session identifier; and transmitting, to one or more user equipment (UEs), an MRB configuration including the MRB identifier and the MBS session identifier.

Example 53. The method of example 52, wherein obtaining the list includes receiving the list from a network node.

Example 54. The method of example 53, wherein the network node is a core network node.

Example 55. The method of example 53, wherein the network node is an Operations, Administration and Maintenance (OAM) node.

Example 56. The method of any one of examples 52-55, wherein the RAN node is a base station.

Example 57. The method of any one of examples 52-55, wherein the RAN node is a central unit (CU) of a distributed base station.

Example 58. The method of any one of examples 52-57, wherein the list is a mapping table.

Example 59. A radio access network (RAN) node configured to perform the method of any one of examples 52-58.

The following additional considerations apply to the foregoing discussion.

In some implementations, “message” is used and can be replaced by “information element (IE)”. In some implementations, “IE” is used and can be replaced by “field”. In some implementations, “configuration” can be replaced by “configurations” or the configuration parameters. In some implementations, “MBS” can be replaced by “multicast” or “broadcast”.

A user device in which the techniques of this disclosure can be implemented (e.g., the UE 102A or 102B) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional alternative structural and functional designs for communicating MBS information through the disclosed principles herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A method, performed by a radio access network (RAN) node, of managing multicast and/or broadcast services (MBS) communications, the method comprising:
receiving, from a network node, a handover request message including a first MBS radio bearer (MRB) identifier associated with a first MRB for an MBS session;
transmitting, to the network node, a handover request acknowledge message including a radio resource control (RRC) reconfiguration message, the RRC reconfiguration message indicating that a user equipment (UE) is to release the first MRB and add a second MRB associated with a second MRB identifier; and
transmitting MBS data of the MBS session to the UE.

2. The method of claim 1, further comprising, before receiving the handover request message:
performing an MBS session join procedure with a core network (CN) for an other user equipment (UE) to join the MBS session; and
transmitting other MBS data of the MBS session to the other UE via the second MRB.

3. The method of claim 2, further comprising, after transmitting the handover request acknowledge message and before transmitting the MBS data to the UE:
performing a random access procedure with the UE.

4. The method of claim 1, wherein the RRC reconfiguration message includes an MRB release configuration including the first MRB identifier and an MRB configuration including the second MRB identifier.

5. The method of claim 1, further comprising, after receiving the handover request message:
determining that the first MRB identifier and the second MRB identifier have different values;
based on the determining, generating the RRC reconfiguration indicating that the UE is to release the first MRB and add the second MRB.

6. The method of claim 1, wherein the RAN node is a target base station and the network node is a source base station.

7. The method of claim 1, wherein the RAN node is a target base station and the network node is a core network (CN).

8. A method, performed by a network node, of managing multicast and/or broadcast services (MBS) communications, the method comprising:
transmitting, to a radio access network (RAN) node, a handover request message including a first MBS radio bearer (MRB) identifier associated with a first MRB for an MBS session;
receiving, from the RAN node, a handover request acknowledge message including a radio resource control (RRC) reconfiguration message, the RRC reconfiguration message indicating that a user equipment (UE) is to release the first MRB and add a second MRB associated with a second MRB identifier; and
transmitting the RRC reconfiguration message to the UE.

9. The method of claim 8, further comprising, before transmitting the handover request message:
performing an MBS session join procedure with a core network (CN) for the UE to join the MBS session; and
transmitting MBS data of the MBS session to the UE via the first MRB.

10. The method of claim 8, wherein the network node is a source base station and the RAN node is a target base station.

11. The method of claim 8, wherein the first MRB identifier is different from the second MRB identifier.

12. The method of claim 8, wherein the RRC reconfiguration message includes an MRB release configuration including the first MRB identifier and an MRB configuration including the second MRB identifier.

13. (canceled)

14. A method, performed by a user equipment (UE), of managing multicast and/or broadcast services (MBS) communications, the method comprising:
receiving MBS data of an MBS session from a first radio access network (RAN) node via a first MBS radio bearer (MRB), the first MRB being associated with a first MRB identifier;
receiving, from the first RAN node, a radio resource control (RRC) reconfiguration message, the RRC reconfiguration message including an MRB release configuration including a first MRB identifier and an MRB configuration including a second MRB identifier associated with a second MRB, the second MRB identifier being different from the first MRB identifier;
based on the RRC reconfiguration message, releasing the first MRB and adding the second MRB; and
receiving other MBS data of the MBS session from a second RAN node via the second MRB.

15. The method of claim 14, further comprising, before receiving the MBS data:
performing an MBS session join procedure with the first RAN node to join the MBS session.

16. The method of claim 14, further comprising, after receiving the RRC reconfiguration message and before receiving the other MBS data:
performing a random access procedure with the second RAN node.

17.-22. (canceled)
